(19) United States
(12) Patent Application Publication
(10) Pub. No.: US 2006/0149463 A1
(43) Pub. Date: Jul. 6, 2006

(54) Route guide information delivery method, route guidance method, information terminal and information delivery center

(75) Inventors: Kimiyoshi Machii, Ibaraki (JP); Yoshinori Endo, Kanagawa (JP); Shinichi Amaya, Kanagawa (JP); Akio Sumizawa, Kanagawa (JP)

Correspondence Address: CROWELL & MORING LLP;INTELLECTUAL PROPERTY GROUP, P.O. BOX 14300, WASHINGTON, DC, 20044-4300, US

(73) Assignees: Xanavi Informatics Corporation, Kanagawa (JP); Hitachi, Ltd., Tokyo (JP); HCX Corporation, Saitama (JP)

(21) Appl. No.: 10/536,794

(22) PCT Filed: Nov. 28, 2003
(86) PCT No.: PCT/JP03/15251

§ 371 Date: Dec. 16, 2005

(30) Foreign Application Priority Data
Nov. 29, 2002 (JP) 2002-348207

(51) Int. Cl. G01C 21/30

(52) U.S. Cl. 701/209

(57) ABSTRACT

Upon receiving a request from a vehicle-mounted device 100, a distribution center 200 executes a recommend route calculation and a guide calculation and transmits recommended route information and the data size of guide information to the vehicle-mounted device 100. The vehicle-mounted device 100 calculates the estimated download time based upon the size of the guide information and displays it. If the driver requests a split download, the vehicle-mounted device 100 outputs a split-download instruction to the distribution center 200. The distribution center 200 transmits to the vehicle-mounted device 100 guide information to be used to guide the vehicle from the start point to the first guidance-requiring intersection. While executing the route guide processing, the vehicle-mounted device 100 downloads the remaining guide information in the background.

### INCORPORATION BY REFERENCE

The disclosure of the following priority application is herein incorporated by reference:
Japanese Patent Application No. 2002-348207 filed Nov. 29, 2002

### TECHNICAL FIELD

The present invention relates to a technology for exchanging information used to provide route guidance between an information terminal device and an information distribution center.

### BACKGROUND ART

There is a technology known in the related art with which route information and guide information obtained through arithmetic operations and transmitted from a guide information distribution center to a mobile recipient such as a vehicle are used by a vehicle-mounted information terminal device to guide the vehicle along the route based upon the received guide information. In conjunction with the guide information distribution center and the vehicle-mounted information terminal device used in the related art, a route search request transmitted from the vehicle side is received at the guide information distribution center and the route information and the guide information obtained at the guide information distribution center through arithmetic operations executed in response to the route search request are transmitted to the vehicle side (see, for instance, patent reference literature 1). When the vehicle is currently located a great distance from the destination, the data size of the guide information calculated at the guide information distribution center is bound to be very large. This gives rise to a problem in that since it takes a long time to receive the information at the vehicle, the route guidance for the user cannot be started immediately by the vehicle-mounted information terminal device.

The present invention provides a route guide information distribution method for split-distributing data with a large volume so as to first distribute only the data that are initially needed, a route guidance method for providing route guidance based upon the split-distributed data, an information terminal that starts route guidance by using the split-distributed data and an information distribution center that distributes only the data that are initially needed by splitting the entirety of the data.

### DISCLOSURE OF THE INVENTION

According to the 1st invention, in a method for distributing route guide information to be used when providing route guidance based upon information related to a recommended route from a start point to a destination and exchanged between an information terminal and an information distribution center, the information distribution center: receives information indicating the start point and the destination from the information terminal; obtains through a search calculation route guide information for a route from the start point to the destination; and splits results of the search calculation and transmits the results in installments to the information terminal.

According to the 2nd invention, in a route guidance method for providing route guidance based upon information related to a recommended route from a start point to a destination and exchanged between an information terminal and an information distribution center, the information terminal: transmits information indicating the start point and the destination to the information distribution center; and starts the route guidance upon receiving an installment of search calculation results for an area near the start point transmitted thereto by splitting results of a search calculation executed at the information distribution center to obtain route guide information.

According to the 3rd invention, in a route guidance method for providing route guidance based upon information related to a recommended route from a start point to a destination and exchanged between an information terminal and an information distribution center by executing in sequence steps (a) to (d) below: (a) the information terminal transmits information indicating the start point and the destination to the information distribution center; (b) the information distribution center obtains route guide information for a route from the start point to the destination by executing a search calculation; (c) the information distribution center splits results of the search calculation and transmits the search calculation results to the information terminal in installments; and (d) the information terminal starts route guidance upon receiving, at least, a search calculation results installment corresponding to an area near the start point.

In the route guidance method according to the 3rd invention, when a state of communication between the information terminal and the information distribution center is poor, the information distribution center can split the search calculation results and transmit the search calculation results to the information terminal in installments. Also, in the route guidance method according to the 3rd invention, when a distance between the start point and the destination is equal to or greater than a predetermined value, the information distribution center can split the search calculation results and transmit the search calculation results to the information terminal in installments. Or, in the route guidance method according to the 3rd invention, when a communication device with a data transmission speed equal to or lower than a predetermined value is connected to the information terminal, the information distribution center can split the search calculation results and transmit the search calculation results to the information terminal in installments.

According to the 4th invention, in a route guidance method for providing route guidance by causing an information terminal, which transmits information indicating a start point and a destination to an information distribution center, and the information distribution center obtains route guide information for a route from the start point to the destination through a search calculation and transmits results of the search calculation to the information terminal in installments by splitting the search calculation results if a specific condition exists, to execute in sequence steps (a) to (d) below: (a) a user is informed of an estimated download time for downloading the search calculation results, determined based upon a physical quantity indicating a size of the search calculation results; (b) the information terminal transmits to the information distribution center information indicating an instruction by the user that the information distribution center split the search calculation results and transmit the search calculation results in installments; (c) upon receiving the information indicating the instruction by the user that the search calculation results be split and transmitted in installments, the information distribution center extracts search calculation results corresponding to an area near the start point from the search calculation results and transmits the extracted search calculation results; and (d) upon receiving the search calculation results corresponding to the area near the start point, the information terminal starts the route guidance.

In the route guidance method according to the 4th invention, the search calculation results include route information of the route from the start point to the destination and guide information used to indicate an advancing direction or the like at each guide point on the route. In this case, the search calculation results corresponding to the area near the start point include at least guide information for a block extending from the start point to a next guide point. It is preferred that the physical quantity indicates a data size of the guide information or a number of guide points contained in the guide information. After starting the route guidance, the information terminal may transmit a request to the information distribution center for remaining guide information. Or, the information terminal may transmit a request to the information distribution center for the remaining guide information to be distributed in units each corresponding to a guide point; and each time the request is received, the information distribution center may transmit guide information extracted in a unit corresponding to a guide point to the information terminal.

According to the 5th invention, a distribution center that distributes route guide information to be used to enable an information terminal to provide route guidance, which is obtained based upon information related to a recommended route from a start point to a destination and exchanged with the information terminal, comprises: a receiving means for receiving a route search request that a route from the start point to the destination be searched, which is transmitted from the information terminal; a search calculation means for obtaining route guide information for the route from the start point to the destination by executing a search calculation in response to the request; an extraction means for extracting search calculation results corresponding to an area near the start point from the search calculation results obtained through the search calculation executed by the search calculation means; and a transmission means for first transmitting the results extracted by the extraction means to the information terminal and then transmitting remaining search calculation results to the information terminal.

According to the 6th invention, an information terminal that provides route guidance by exchanging information related to a recommended route from a start point to a destination with an information distribution center, comprises: a transmission/reception means for transmitting information indicating the start point and the destination to the information distribution center and receiving search calculation results constituting route guide information obtained through an arithmetic operation executed at the information distribution center; and a guidance starting means for starting the route guidance upon receiving at least search results corresponding to an area near the start point and constituting part of the route guide information obtained through the arithmetic operation executed at the information distribution center, split and transmitted in installments.

### BRIEF DESCRIPTION OF THE DRAWINGS

FIG. 1 shows the overall configuration of an embodiment that includes the information terminal and the information distribution center according to the present invention;

FIG. 2 is a system block diagram of the information terminal according to the present invention;

FIG. 3 shows the structure of the map data displayed at the information terminal according to the present invention;

FIG. 4 shows the structure of the data used in a route search executed at the information distribution center according to the present invention;

FIG. 5 presents a flowchart of the operations executed at the information terminal and the information distribution center according to the present invention;

FIG. 6 shows the display monitor at the information terminal according to the present invention, on which the current vehicle position is indicated in a road map;

FIG. 7 shows a subroutine that may be executed in step S100 in the flowchart presented in FIG. 5;

FIG. 8 shows the display monitor at the information terminal according to the present invention, on which a destination is set;

FIG. 9 shows the display monitor at the information terminal according to the present invention, on which route search conditions are displayed;

FIG. 10 shows the display monitor at the information terminal according to the present invention, on which a message indicating that a route search is in progress is displayed;

FIG. 11 shows a subroutine that may be executed in step S700 in the flowchart presented in FIG. 5;

FIG. 12 shows a subroutine that may be executed in step S200 in the flowchart presented in FIG. 5;

FIG. 13 shows the display monitor at the information terminal according to the present invention, with an inquiry to the user as to whether or not the guide information is to be split-downloaded;

FIG. 14 shows the display monitor at the information terminal according to the present invention, with a display brought up while the guide information is split-downloaded in the background;

FIG. 15 shows a subroutine that may be executed in step S700 in the flowchart presented in FIG. 5;

FIG. 16 shows the display monitor at the information terminal according to the present invention, with an inquiry to the user as to whether or not the guide information is to be split-downloaded;

FIG. 17 shows a subroutine that may be executed in step S200 in the flowchart presented in FIG. 5;

FIG. 18 shows the display monitor at the information terminal according to the present invention, on which a message indicating that the guide information is to be split-downloaded is displayed;

FIG. 19 shows a subroutine that may be executed in step S100 in the flowchart presented in FIG. 5;

FIG. 20 shows a subroutine that may be executed in step S700 in the flowchart presented in FIG. 5;

FIG. 21 shows a subroutine that may be executed in step S200 in the flowchart presented in FIG. 5;

FIG. 22 shows the display monitor at the information terminal according to the present invention, on which a message indicating that the guide information is to be split-downloaded is displayed;

FIG. 23 shows a subroutine that may be executed in step S200 in the flowchart presented in FIG. 5;

FIG. 24 shows a subroutine that may be executed in step S100 in the flowchart presented in FIG. 5;

FIG. 25 shows the display monitor at the information terminal according to the present invention, on which a message indicating that the guide information is to be split-downloaded is displayed;

FIG. 26 shows a subroutine that may be executed in step S100 in the flowchart presented in FIG. 5;

FIG. 27 shows a subroutine that may be executed in step S200 in the flowchart presented in FIG. 5;

FIG. 28 shows the display monitor at the information terminal according to the present invention, on which a message indicating that guidance to the first waypoint is now starting is displayed;

FIG. 29 shows the display monitor at the information terminal according to the present invention, with an inquiry to the user as to whether or not the route search information to the next waypoint is to be downloaded;

FIG. 30 shows the display monitor at the information terminal according to the present invention, on which a message indicating that the route search information to the next waypoint is to be downloaded;

FIG. 31 shows a subroutine that may be executed in step S200 in the flowchart presented in FIG. 5; and

FIG. 32 presents a flowchart of the operations executed at the information terminal and the information distribution center in a seventh embodiment.

### BEST MODE FOR CARRYING OUT THE INVENTION

### First Embodiment

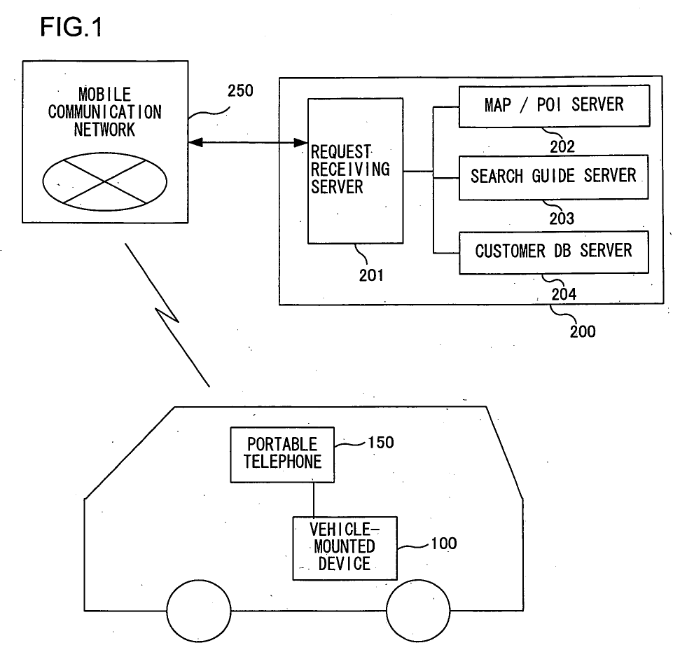

In reference to FIGS. 1 to 14, the first embodiment achieved by adopting the information terminal (or the information terminal device) according to the present invention in a car navigation system (hereafter referred to as a vehicle-mounted device) 100 is explained. FIG. 1 shows the vehicle-mounted device 100 achieved in the first embodiment, a distribution (or delivery) center 200 that distributes or delivers map information and route search information to the vehicle-mounted device 100, a portable telephone 150 used to exchange various types of data between the vehicle-mounted device 100 and the distribution center 200 and a mobile communication network 250. As shown in FIG. 1, the portable telephone 150 is connected to the vehicle-mounted device 100. The vehicle-mounted device 100 is able to transmit a request for detailed map information, route information and guide information needed for route guidance to the distribution center 200 from the portable telephone 150 via the mobile communication network 250. It is also capable of receiving at the portable telephone 150 the detailed map information, the route information and the guide information transmitted from the distribution center 200 via the mobile communication network 250. It is to be noted that a car phone, a communication LAN or a communication device provided for exclusive use in conjunction with the vehicle-mounted device may be utilized instead of the portable telephone 150.

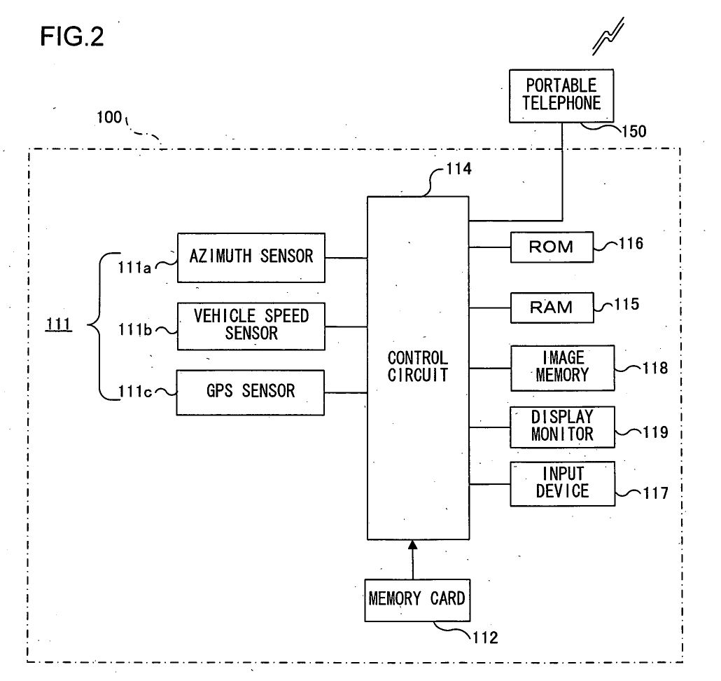

FIG. 2 is a system block diagram showing the structure of the vehicle-mounted device 100. Reference numeral 111 in FIG. 2 indicates a current position detection device that detects the current position of the vehicle, which may be constituted with, for instance, an azimuth sensor 111a for detecting the advancing azimuth of the vehicle, a vehicle speed sensor 111b for detecting the vehicle speed and a GPS sensor 111c for detecting a GPS signal transmitted from a GPS satellite. Reference numeral 112 indicates a memory card used to store simplified road map display data for the entire nation and road map display data having been received, which is constituted with a non-volatile semiconductor memory and can be detachably loaded into the vehicle-mounted device 100. Reference numeral 114 indicates a control circuit that implements overall control of the device and is constituted with a microprocessor and its peripheral circuits. The control circuit 114 uses a RAM 115 as its work area when implementing various types of control to be detailed later by executing a control program stored in a ROM 116.

Reference numeral 117 indicates an input device having various switches through which the destination for the vehicle and the like are input. Reference numeral 118 indicates an image memory in which image data used to display images at a display monitor 119 are stored. The image data are generated by using road map drawing data, various types of graphic data and the like. The image data stored in the image memory 118 are read out as needed to be used for an image display at the display monitor 119. At the display monitor 119, route information and guide information are displayed together with a road map.

The vehicle-mounted device 100 structured as described above executes various types of navigation based upon the subject vehicle position information provided by the current position detection device 111 and the various types of data stored in the memory card 112. For instance, it displays a road map of an area around the subject vehicle position having the subject vehicle position indicated therein at the display monitor 119 and guides the driver based upon the route information and the guide information downloaded from the distribution center 200.

A request receiving server at the distribution center 200 in FIG. 1, which is indicated by reference numeral 201, receives the subject vehicle position information and a map•route distribution request from the vehicle-mounted device 100 and executes processing as requested. Reference numeral 202 indicates a map•POI server having stored therein a detailed roadmap and POI information (point of interest: information regarding site-seeing spots and various types of facilities) for the entire nation, which outputs data to the request receiving server 201 in response to a request issued by the request receiving server 201. Reference numeral 203 indicates a search•guide server that executes arithmetic operations for route search and route guidance in response to a request from the request receiving server 201 and outputs the results of the arithmetic operations (recommended route information) to the request receiving server 201. Reference numeral 204 indicates a customer DB server. The map•POI data or the results of the arithmetic operations for the route search and the route guidance requested by the vehicle-mounted device 100 are a first stored into the customer DB server 204 in correspondence to the specific customer's vehicle-mounted device 100 and are then distributed to the vehicle-mounted device 100 via the request receiving server 201. Each vehicle-mounted device 100 is preassigned with an ID code used to identify the subject vehicle, and various types of information are stored in a storage area allocated in correspondence to the ID code at the customer DB server 204.

Data Structures

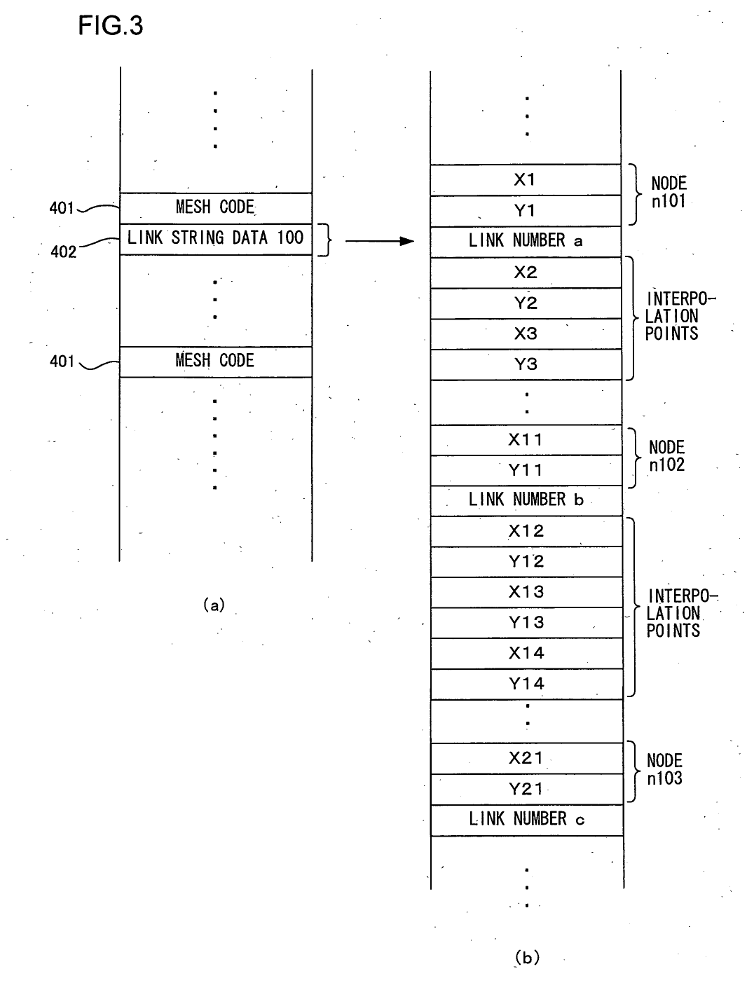

FIGS. 3(a) and 3(b) show the structure of the map data used for map display at the vehicle-mounted device 100. The map data are link string data grouped in correspondence to individual mesh areas each assigned with a mesh code and stored. It is to be noted that a data structure is adopted for the link string data in which each road is expressed by using nodes such as intersections and links connecting the individual nodes. The term “mesh areas” refers to equally divided blocks of the road map. A number used to identify the subject mesh area is stored in a mesh code storage area 401. In a link string data storage area 402, the positional coordinates X and Y of each node, link numbers of the links present between the nodes and the positional coordinates X and Y of interpolation points further dividing the links into shorter segments are stored in their respective storage areas, as shown in FIG. 3(b). These positional coordinates are used as shape data in the map display and locator processing.

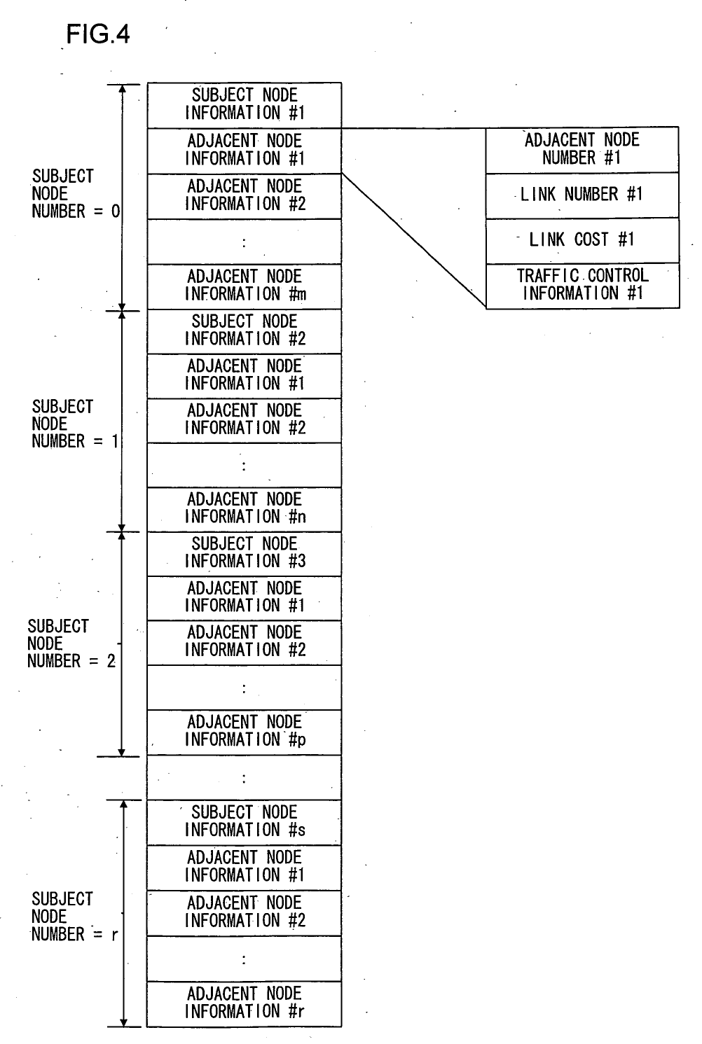

FIG. 4 shows the structure of the route search data. Unlike the map data, the route search data are constituted with branching point information, intersection information and the like which do not bear direct relevance to road shapes. As shown in FIG. 4, in correspondence to each point (node) connecting links each of which is the smallest unit of data used to express a road, node information indicating connecting relations with other nodes is stored. Each set of node information contains subject node information and adjacent node information with the positional coordinates of the subject node stored in the subject node information. As adjacent node information corresponding to a given adjacent node, the adjacent node number, the number assigned to the link connecting the subject node to the adjacent node, the link cost of the link and traffic control information with regard to the link are stored as shown in the figure. In addition, the individual sets of node information are stored in the order matching the order in which the links are connected and, as a result, the node number of a given subject node can be ascertained based upon the order in which the set of node information is stored.

The route search calculation is executed by using the route search data described above. Route guide data resulting from the route search are created by extracting the nodes present on the recommended route from the start point to the destination from the route search data through a known method. The Route guide data include guide point data. The guide point data are constituted with offset data for enlarged intersection area map data and audio data. When guiding the vehicle along the route, these offset data are referenced as the vehicle reaches a point several hundred meters from a guide point to display an enlarged intersection area map on the display monitor and output the audio data through a speaker, thereby providing the driver with route guidance. Namely, the route information mentioned earlier is constituted with recommended route data indicating the recommended route with a plurality of nodes and the guide information mentioned earlier is constituted with guide point data, i.e., the enlarged map data and the audio data obtained by referencing the offset data.

In conjunction with the data structured as described above, upon receiving a route search request and a detailed map request as well as the information indicating the current vehicle position, a waypoint and a destination transmitted from the vehicle-mounted device 100, the distribution center 200 executes a recommended route calculation and a guide calculation based upon the information received from the vehicle-mounted device 100. Then, the recommended route information and the guide information resulting from the calculations and the detailed map information are transmitted from the distribution center 200 to the vehicle-mounted device 100. Based upon the recommended route information, the guide information and the detailed map information received from the distribution center 200, the vehicle-mounted device 100 is able to guide the vehicle along the route. However, if the vehicle is currently located a great distance away from the destination, the volume of the transmission data is bound to be very large and it will take a long time for the vehicle-mounted device 100 to receive all the information and start providing guidance. Accordingly, the guide information is split-downloaded (i.e. is divided and downloaded) as described below in the first embodiment.
(1) The distribution center 200 transmits to the vehicle-mounted device 100 the route information of the route extending from the start point to the destination, which results from the search calculation, and also transmits information indicating the data size of the guide information to be downloaded to the vehicle-mounted device 100.
(2) The vehicle-mounted device 100 displays the entire route from the start point to the destination at the monitor. At this time, the vehicle-mounted device 100 calculates the estimated download time based upon the size of the guide information to be downloaded and prompts the driver to decide whether or not to split-download the guide information by bringing up the estimated download time on display.
(3) If the driver requests a split download, the vehicle-mounted device 100 outputs a split-download instruction to the distribution center 200.
(4) The distribution center 200 transmits to the vehicle-mounted device 100 guide information to be used to guide the vehicle from the start point to the first guidance-requiring intersection and the route guidance starts.
(5) While executing the route guide processing, the vehicle-mounted device 100 downloads the remaining guide information in units of individual guidance-requiring intersections in the background.

The present invention is explained in further detail below in reference to an example in which the necessary detailed map data are already stored in the memory card 112 at the vehicle-mounted device 100 and the route search request is transmitted to the distribution center 200.

Description in Reference to the Flowcharts

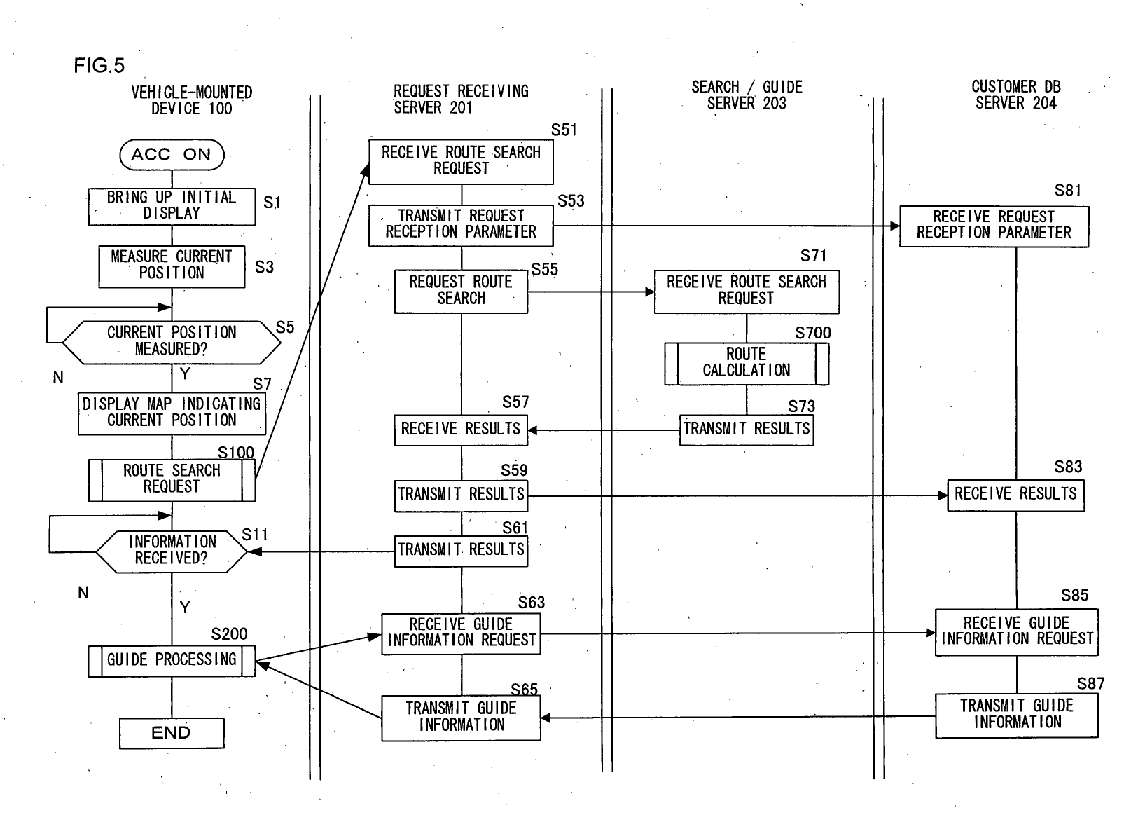

FIG. 5 presents a flowchart of the operations executed by the vehicle-mounted device 100, the request receiving server 201, the search•guide server 203 and the customer DB server 204. The operational flow in FIG. 5 is achieved by executing the processing program for the vehicle-mounted device 100 at the control circuit 114, executing the processing program for the request receiving server 201 at the request receiving server 201, executing the processing program for the search•guide server 203 at the search•guide server 203 and executing the processing program for the customer DB server 204 at the customer DB server 204.

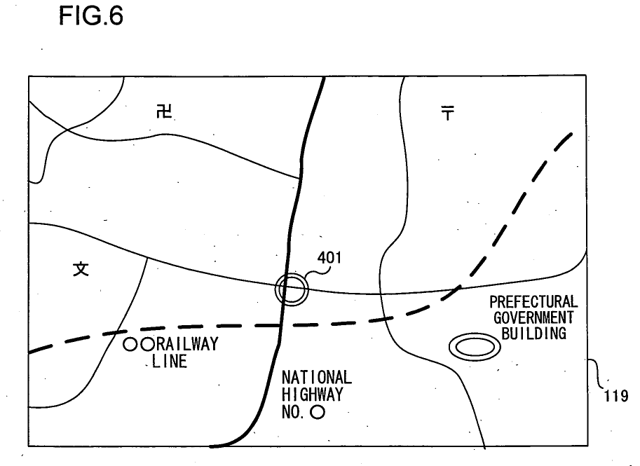

As the ignition key is set to an accessory on (ACC ON) position, power to the vehicle-mounted device 100 is turned on and the program that enables the vehicle-mounted device 100 to execute the processing shown in FIG. 5 is started up. In step S1, a map of an area around the vehicle, which had been on display immediately before the vehicle-mounted device 100 was turned off most recently, is brought up on display as an initial screen. In step S3, the current vehicle position is measured or detected. After deciding that the subject vehicle position has been measured in step S5, the operation proceeds to step S7 to indicate the current vehicle position in a map of an area around the current vehicle position at the display monitor 119 as shown in FIG. 6 before the operation proceeds to step S100. Reference numeral 401 in FIG. 6 indicates a subject vehicle position mark. In step S100, a search request for a route from the current vehicle position to a destination is transmitted to the distribution center 200 before the operation proceeds to step S11. The arithmetic operation subroutine executed in step S100 is to be described in detail later. In step S11, the operation waits in standby for the reception of route search information having been requested through the subroutine in step S100.

At the distribution center 200, upon receiving the route search request from the vehicle-mounted device 100 in step S51, the operation proceeds to step S53 to transmit a request reception parameter to the customer DB server 204 and then the operation proceeds to step S55. In step S55, a route search request is transmitted to the search•guide server 203 based upon the route search request issued by the vehicle-mounted device 100.

At the search•guide server 203, upon receiving the route search request from the request receiving server 201 in step S71, the operation proceeds to step S700 to execute a recommended route calculation and a guide calculation and then the operation proceeds to step S73. The arithmetic operation subroutine executed in step S700 is to be described in detail later. In step S73, route information and guide information resulting from the arithmetic operations are transmitted to the request receiving server 201.

At the request receiving server 201, upon receiving the arithmetic operation results from the search guide•server 203 in step S57, the operation proceeds to step S59 to transmit the results of the arithmetic operations executed by the search•guide server 203 to the customer DB server 204 before the operation proceeds to step S61. In step S61, the full route information and the data size of the guide information among the arithmetic operation results provided by the search•guide server 203 are transmitted to the vehicle-mounted device 100.

At the customer DB server 204, after receiving the request reception parameter in step S81, the results of the arithmetic operations having been executed at the search•guide server 203, which have been received from the request receiving server 201, are stored into the storage area allocated in correspondence to the ID number of the vehicle-mounted device 100.

After deciding that the route information and the information indicating the data size of the guide information provided by the distribution center 200 have been received in step S11, the operation at the vehicle-mounted device 100 proceeds to the subroutine in step S200 to execute guide processing. Instep S200, a request for the guide information that has not yet been received is transmitted to the distribution center 200. Upon receiving the guide information, the guide processing is started based upon the received guide information. It is to be noted that the arithmetic operation subroutine executed in step S200 is to be described in detail later.

The following is a detailed explanation of the operational flow through which the route search request is transmitted from the vehicle-mounted device 100 to the distribution center 200 and the guide processing is eventually executed. As explained earlier, the information initially transmitted from the distribution center 200 to the vehicle-mounted device 100 in the first embodiment includes the information indicating the data size of the guide information as well as the route information. Thus, the user is able to choose whether or not the guide information yet-to-be received should be split-downloaded from the distribution center 200 based upon the data size of the guide information and the estimated download time calculated by the vehicle-mounted device 100.

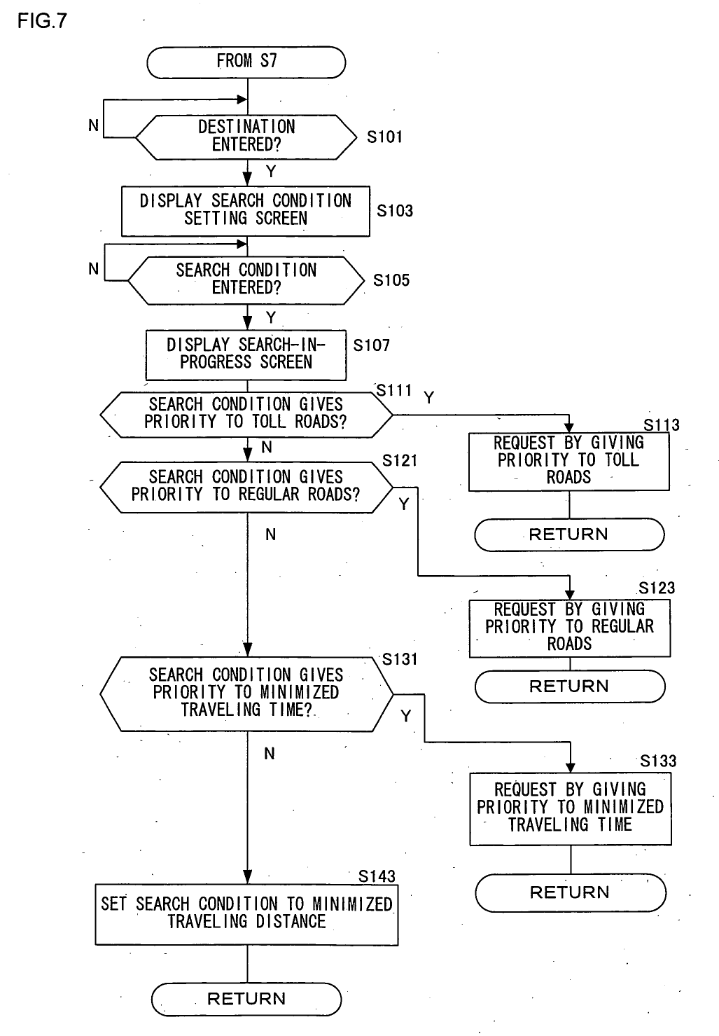

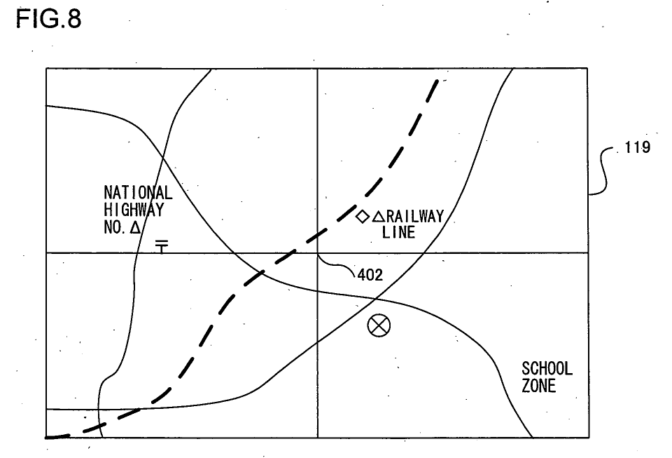

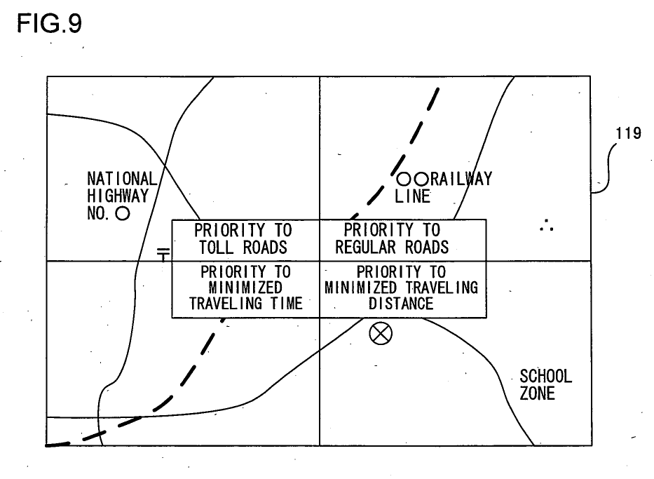

FIG. 7 presents an example of a subroutine that may be executed in step S100 in the first embodiment. Through this subroutine processing, a specific condition to be indicated in the route search request transmitted from the vehicle-mounted device 100 to the distribution center 200 is determined. As the current vehicle position is indicated at the display monitor 119 as shown in FIG. 6 in step S7 in the main routine shown in FIG. 5, the operation proceeds to execute the subroutine in step S100. In step S101, the operation waits in standby for the user to set a destination through a specific operation. A FIG. 8 shows a display brought up on the display monitor 119 to indicate the destination having been set. A point 402 at which the lines extending perpendicular to each other cross in the display at the display monitor 119 indicates the destination. After deciding in step S101 that a destination has been set, the operation proceeds to step S103 to display the search condition setting screen shown in FIG. 9. A specific condition to be applied when the distribution center 200 executes the route search, which is selected by the user, is set as the search condition. The selection may be made from, for instance, the following conditions.
(1) The route search is to be executed by giving priority to toll roads.
(2) The route search is to be executed by giving priority to regular roads.
(3) The route search is to be executed so as to minimize the traveling time.
(4) The route search is to be executed so as to minimize the traveling distance.

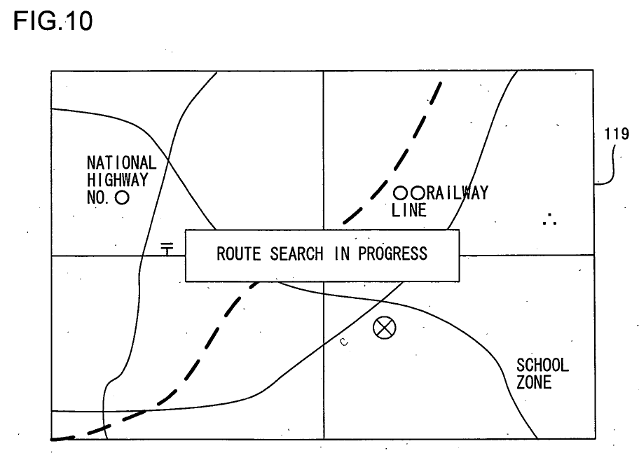

Upon deciding in step S105 that the search condition has been set, the display with a message indicating that the search is in progress shown in FIG. 10 is brought up at the display monitor 119, and then the operation proceeds to step S111. If it is decided in step S111 that the search condition having been set by the user in steps S103 through S105 gives priority to toll roads, the operation proceeds to step S113. In step S113, a route search request indicating the search condition giving priority to toll roads as well as the current position and the destination is transmitted to the distribution center 200, and then the operation returns to the main routine to execute the main routine processing in step S11 and subsequent steps.

If, on the other hand, it is decided in step S111 that the search condition having been set by the user in steps S103 through S105 does not give priority to toll roads, the operation proceeds to step S121. If it is decided in step S121 that the search condition having been set by the user in steps S103 through S105 gives priority to regular roads, a route search request indicating the search condition giving priority to regular roads as well as the current position and the destination is transmitted to the distribution center 200 in step S123 before the operation returns to the main routine to execute the main routine processing in step S11 and subsequent steps.

If, on the other hand, it is decided in step S121 that the search condition having been set by the user in steps S103 through S105 does not give priority to regular roads, the operation proceeds to step S131. If it is decided in step S131 that the search condition having been set by the user in steps S103 through S105 gives priority to minimize traveling time, a route search request indicating the search condition given priority to minimized traveling time as well as the current position and the destination is transmitted to the distribution center 200 in step S133 before the operation returns to the main routine to execute the main routine processing in step S11 and subsequent steps.

If it is decided in step S131 that the search condition having been set by the user in steps S103 through S105 does not give priority to minimized traveling time, the operation proceeds to step S143 to transmit a route search request indicating the search condition giving priority to minimized traveling distance as well as the current position and the destination to the distribution center 200 before the operation returns to the main routine to execute the main routine processing in step S11 and subsequent steps.

Thus, the information indicating the current vehicle position and the destination and the route search condition determined through the subroutine is transmitted to the distribution center 200 together with the ID number used to identify the vehicle. As explained earlier, upon receiving these data, the distribution center 200 accesses the search•guide server 203 to execute the route calculation in step S700 in FIG. 5.

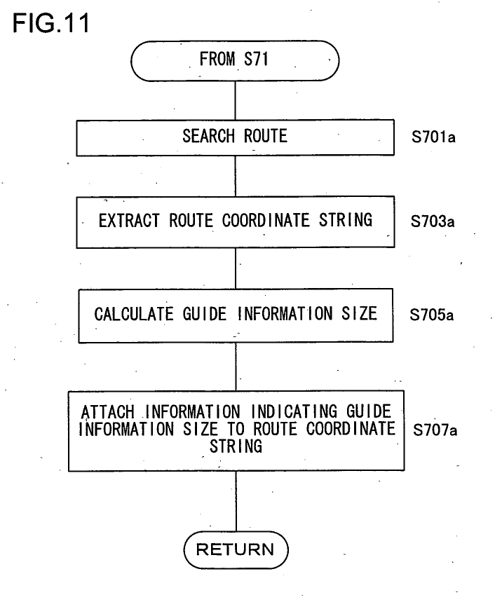

FIG. 11 shows the subroutine executed in step S700 in the first embodiment. As the search•guide server 203 receives the route search request from the request receiving server 201 in step S71 in FIG. 5, the operation proceeds to step S700. In step S701a, the route search calculation is executed based upon the position information and the route search condition having been transmitted from the vehicle-mounted device 100. In step S703a, a route coordinate string is extracted from the recommended route resulting from the route search calculation. The route coordinate string contains the positional coordinates X and Y of a plurality of nodes present in the roads on the recommended route. In step S705a, the size (data volume) of the guide information is calculated based upon the results of the calculation having been executed in step S701a. In step S707a, the data indicating the guide information size calculated in step S705a are appended to the route information (the route coordinate string data having been obtained in step S703a) to be transmitted to the vehicle-mounted device 100, before the operation returns to the main routine. Then, in step S73 in the main routine, the route information and the guide information obtained through the arithmetic operations executed in the subroutine in step S700 are transmitted to the request receiving server 201.

As explained earlier, the request receiving server 201 first transmits the arithmetic operation results received from the search•guide server 203 to the customer DB server 204 in step S59 and then the operation proceeds to step S61. In step S61, the request receiving server 201 transmits the route information having the guide information size data attached thereto to the vehicle-mounted device 100.

At the vehicle-mounted device 100, upon deciding in step S11 that the route information provided by the distribution center 200 has been received, the operation proceeds to the subroutine in step S200.

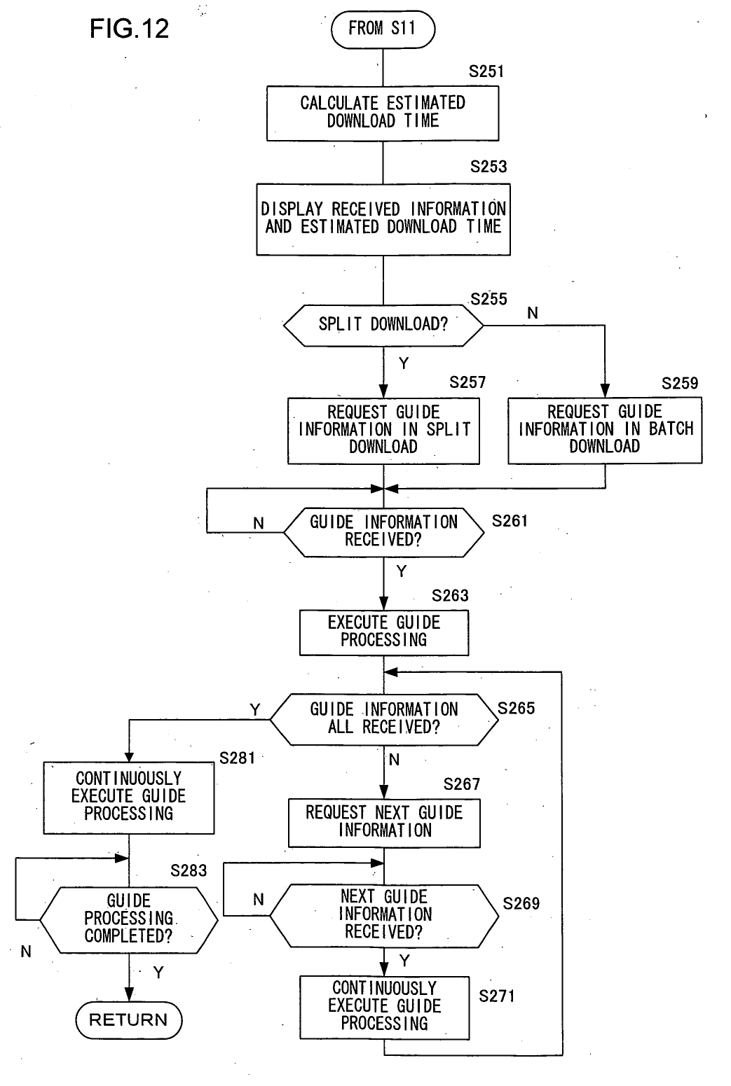

FIG. 12 shows the subroutine executed in step S200 in the first embodiment. Through this subroutine processing, the guide information is received and used for route guidance. In step S251, an estimated download time required to receive all the guide information is calculated. This calculation is executed through the following procedure. First, the effective download speed at which the route information received from the distribution center 200 has been downloaded is calculated by dividing the route information size by the length of time having been spent downloading the route information. Then, the estimated download time is calculated by dividing the size of the yet-to-be received guide information, which is indicated in the downloaded information, by the effective download speed.

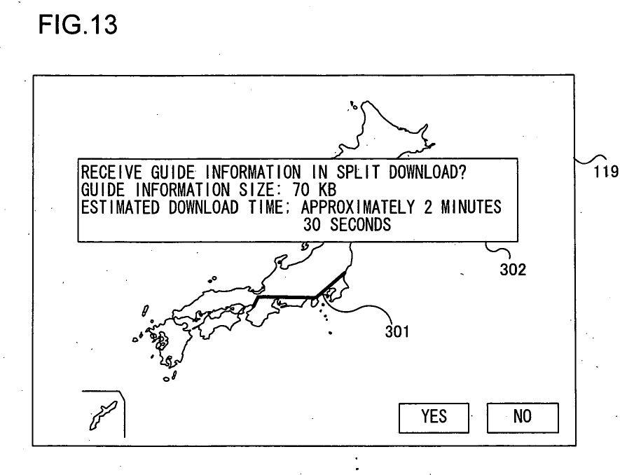

In step S253, the route information having been received in step S11 and the estimated download time having been calculated in step S251 are brought up on display at the display monitor 119. FIG. 13 shows the screen brought up on display at the display monitor 119 in step S253. As shown in FIG. 13, a bold line 301 indicating the recommended route and a dialogue 302 asking the user whether or not the yet-to-be received guide information is to be split-downloaded are displayed at the display monitor 119. Through the dialogue 302, which includes indicated therein the guide information size and the estimated download time having been calculated in step S251, the user is asked whether or not he wishes to split-download the guide information.

In step S255, a decision is made with regard to the download method selected by the user, through which the yet-to-be received guide information is to be downloaded. If it is decided in step S255 that the user has opted for a split download, the operation proceeds to step S257 to transmit a split-download request to the distribution center 200. If, on the other hand, it is decided in step S255 that the user has not opted for a split download, the operation proceeds to step S259 to transmit to the distribution center 200 a request for downloading the yet-to-be received guide information all at once in a batch.

In step S63 in FIG. 5, the request receiving server 201 outputs a request for the customer DB server 204 to transmit part of or all of the yet-to-be transmitted guide information stored therein in response to the distribution request from the vehicle-mounted device 100. In response to the request from the request receiving server 201, which is received in step S85, i.e., in response to the distribution request from the vehicle-mounted device 100, the customer DB server 204 transmits to the request receiving server 201 part of the yet-to-be transmitted guide information stored therein or all the yet-to-be transmitted guide information stored therein in step S87. The request receiving server 201 transmits the yet-to-be transmitted guide information received from the customer DB server to the vehicle-mounted device 100 in step S65.

When the customer DB server 204 transmits the yet-to-be transmitted guide information stored therein in divided installments in response to the request from the request receiving server 201 having been received in step S85, i.e., in response to the distribution request from the vehicle-mounted device 100, the guide information is divided in correspondence to individual guidance-requiring intersections. If the distances between guidance-requiring intersections are small, the guide information should be divided so as to allow a plurality of guidance-requiring intersections to be included in a single divided block of guide information.

In step S261 in FIG. 12, the vehicle-mounted device 100 waits in standby until the first block of guide information transmitted from the distribution center 200 for the split-download in response to the request issued in step S257 is received or the guide information transmitted in a batch from the distribution center 200 in response to the request issued in step S259. Upon deciding in step S261 that the requested guide information has been received, the guide processing starts in step S263 based upon the guide information having been received in step S261. The information having been received is stored into the RAM 115 at the vehicle-mounted device 100. In step S265, a decision is made as to whether or not all the information necessary to provide the route guidance has been received. If it is decided in step S265 that all the information needed to provide the route guidance has been received, the operation proceeds to step S281 to continuously execute the guide processing based upon the received guide information. In step S283, the operation waits in standby for the completion of the guide processing. Upon deciding in step S283 that the guide processing has ended, the operation returns to the main routine to end the main routine program.

If it is decided in step S265 that there is still information needed for the route guidance that has not been received yet, the operation proceeds to step S267 to output a request for the distribution center 200 to transmit the next block of guide information.

In response to the distribution request received from the vehicle-mounted device 100, the request receiving server 201 issues a request for the yet-to-be transmitted guide information stored at the customer DB server 204 in step S63. In response to the request from the request receiving server 201 received in step S85, i.e., in response to the distribution request from the vehicle-mounted device, the customer DB server 204 transmits a divided block of the yet-to-be transmitted guide information stored therein to the request receiving server 201 in step S87. The request receiving server 201 transmits the yet-to-be transmitted guide information having been received from the customer DB server to the vehicle-mounted device 100 in step S65.

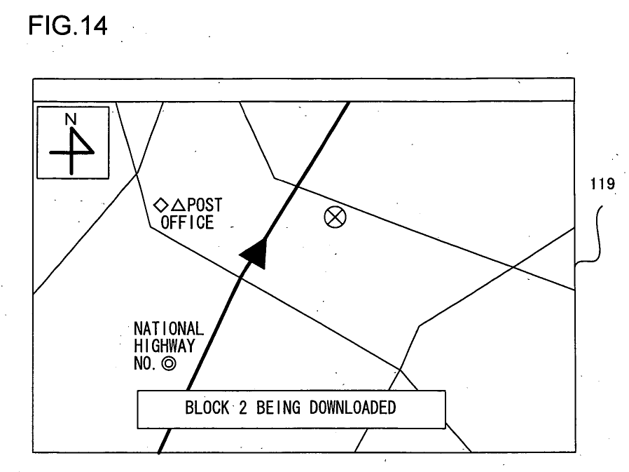

In step S269 in FIG. 12, the vehicle-mounted device 100 waits in standby until the guide information having been requested in step S267 is received. After deciding in step S269 that the requested guide information has been received, the guide processing is continuously executed based upon the received guide information in step S271 before the operation returns to step S265. Subsequently, the processing in steps S267 through S271 and the processing in steps S63 and S65 and steps S85 and S87 are repeatedly executed respectively at the vehicle-mounted device 100 and the distribution center 200 as described above, until all the divided blocks of guide information are downloaded at the vehicle-mounted device 100. Namely, the vehicle-mounted device 100 requests the yet-to-be received guide information in the background while continuously executing the guide processing based upon the received guide information, as shown in FIG. 14, whereas the distribution center 200 repeatedly transmits a divided block of guide information each time the yet-to-be received information distribution request from the vehicle-mounted device 100 is received until all the guide information is received at the vehicle-mounted device 100.

The following advantages are achieved through the first embodiment.
(1) Based upon the guide information size and the estimated download time indicated at the display monitor 119, the user is able to decide whether or not to receive the guide information in a split download. As a result, if the user wishes to depart the start point immediately by following the route guidance provided by the vehicle-mounted device 100, the user is able to ensure that the route guidance by the vehicle-mounted device 100 becomes available as soon as the guide information corresponding to an area around the current vehicle position is downloaded by opting for a split download.
(2) By opting for a split-download when the guide information size is large and the estimated download time is significant, the risk of an increased communication time due to a possible communication failure/retry that may occur during a batch download can be avoided, and the total length of time required for the download can be reduced.
(3) By opting for a split-download when the user driving the vehicle between tall buildings or in a mountainous area judges that the reception is poor, the risk of an increased communication time due to a possible communication failure/retry that may occur during a batch download can be avoided, and the total length of time required for the download can be reduced.
(4) By opting for a batch download when the guide information size is small and the estimated download time is short, the user is able to use the portable telephone 150 immediately by disconnecting it from the vehicle-mounted device 100 after the guide information download ends.
(5) Even when the guide information size is large and the estimated download time is significant, the risk of a communication failure is low if the vehicle is in a stationary state and the reception is good. Under such circumstances, the user may opt for a batch download to reduce the download time.

Second through seventh embodiments of the information terminal according to the present invention are explained below. The structures shown in FIGS. 1 through 4 and 6 are also adopted in these embodiments and the following explanation focuses on the contents of the subroutines executed in the embodiments.

### Second Embodiment

The information initially transmitted from the distribution center 200 to the vehicle-mounted device 100 includes information indicating the number of guidance-requiring intersections contained in the guide information, as well as the route information in the second embodiment. Based upon the number of guidance-requiring intersections contained in the guide information and the estimated download time calculated by the vehicle-mounted device 100, the user is able to decide whether or not the yet-to-be received guide information should be received through a split download. The following is an explanation of the second embodiment.

The vehicle-mounted device 100 transmits to the distribution center 200 information indicating the current vehicle position and the destination and the route search condition determined through the subroutines executed in step S100 together with the ID number to be used to identify the vehicle. As explained earlier, the distribution center 200 accesses the search•guide server 203 to execute a route calculation in step S700.

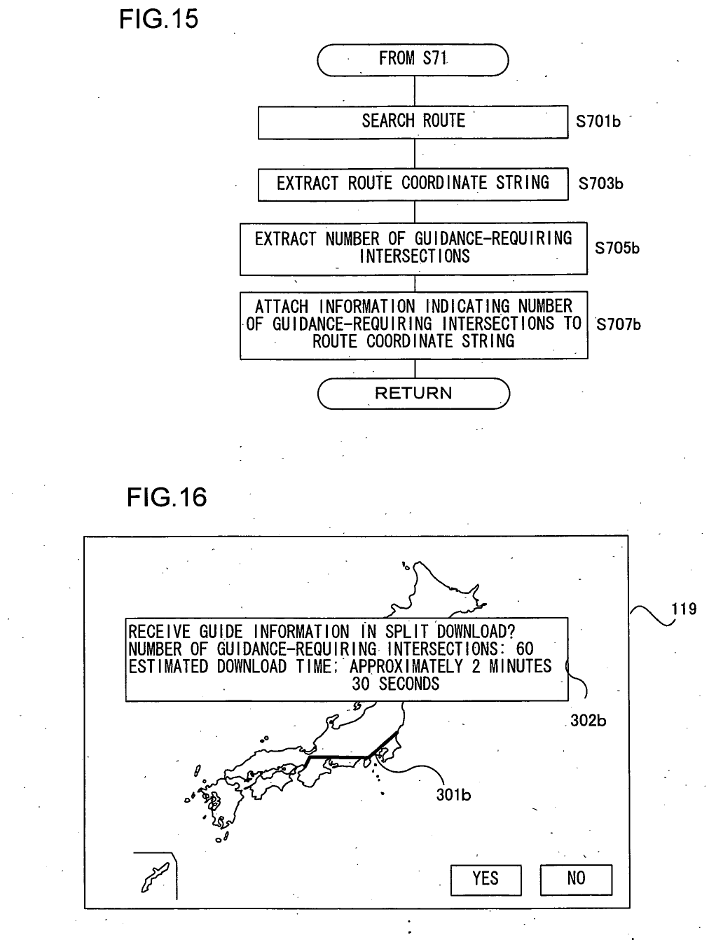

FIG. 15 shows the subroutine executed in step S700 in the second embodiment. As the search•guide server 203 receives the route search request from the request receiving server 201 in step S71 in FIG. 5, the operation proceeds to step S700. In step S701b, the route search calculation is executed based upon the position information and the route search condition having been transmitted from the vehicle-mounted device 100. In step S703b, a route coordinate string is extracted from the recommended route resulting from the route search calculation. In step S705b, data indicating the number of guidance-requiring intersections are extracted from the results of the calculation having been executed in step S701b. In step S707b, the data indicating the number of guidance-requiring intersections obtained in step S705b are appended to the route information (the route coordinate string data having been obtained in step S703a) to be transmitted to the vehicle-mounted device 100 in the initial installment, before the operation returns to the main routine. Then, in step S73 in the main routine, the route information and the guide information obtained through the arithmetic operations executed in the subroutine in step S700 are transmitted to the request receiving server 201.

The request receiving server 201 executes steps S57 through S61 in FIG. 5, as in the first embodiment. In step S61, it transmits the route information having attached thereto the data indicating the number of guidance-requiring intersections to the vehicle-mounted device 100.

At the vehicle-mounted device 100, upon deciding in step S11 that the route information has been provided by the distribution center 200 has been received, the operation proceeds to the subroutine in step S200.

The subroutine executed in step S200 in the second embodiment is identical to the subroutine in FIG. 12 executed in the first embodiment. However, the method with which the estimated download time for downloading the yet-to-be received guide information is calculated in step S251 is different from that adopted in the first embodiment. In the second embodiment, the effective download speed with which the route information has been downloaded is first calculated by dividing the size of the route information received from the distribution center 200 by the length of time spent downloading the route information. Next, a predetermined information size corresponding to a single guidance-requiring intersection is multiplied with the number of guidance-requiring intersections indicated in the received data to estimate the size of the yet-to-be received guide information. Then, the estimated download time is calculated by dividing the estimated size of the yet-to-be received guide information by the effective download speed.

In step S253, the route information having been received in step S11 and the estimated download time having been calculated in step S251 are brought up on display at the display monitor 119. FIG. 16 shows the screen brought up on display at the display monitor 119 in step S253. As shown in FIG. 16, a bold line 301b indicating the recommended route and a dialogue 302b asking the user whether or not the yet-to-be received guide information is to be split-downloaded are displayed at the display monitor 119. Through the dialogue 302b, which includes indicating the number of guidance-requiring intersections and the estimated download time having been calculated in step S251 the user is asked whether or not he wishes to split-download the guide information.

Since the operation executed in step S255 and subsequent steps is completely identical to the operation executed in step S255 and subsequent steps in the subroutine in the first embodiment, its explanation is omitted.

### Third Embodiment

In the third embodiment, depending upon the state of radio waves exchanged between the portable telephone 150 and the mobile communication network 250, a decision is made as to whether or not the vehicle-mounted device 100 is to receive the yet-to-be received guide information from the distribution center 200 in a split download. If the effective speed with which the route information has been downloaded is equal to or lower than a predetermined threshold value, it is judged that the radio wave state (reception) is poor and accordingly, the vehicle-mounted device opts for a split download, whereas if the effective speed with which the route information has been downloaded is higher than the predetermined threshold value, the reception is judged to be good and accordingly, the user is allowed to decide whether or not the guide information is to be received through a split download, as has been explained in reference to the first embodiment and the second embodiment. The following is an explanation of the third embodiment.

At the vehicle-mounted device 100, upon deciding in step S11 that the route information transmitted from the distribution center 200 as in the first and second embodiments explained earlier has been received, the operation proceeds to the subroutine in step S200.

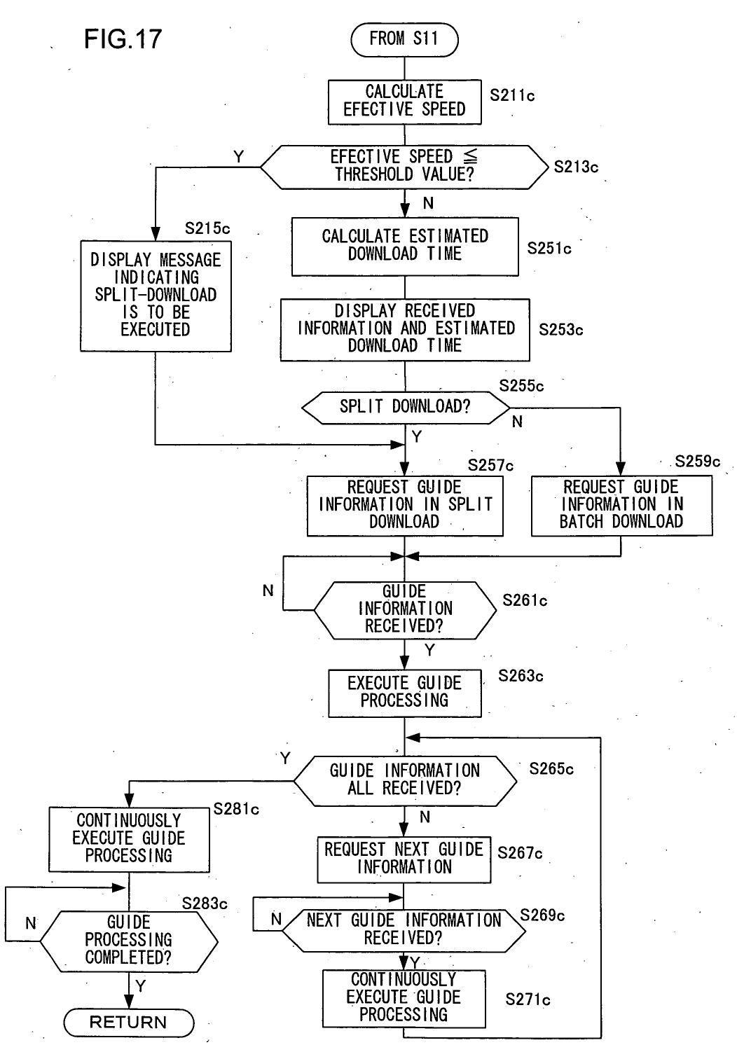

FIG. 17 shows the subroutine executed in step S200 in the third embodiment. Since the subroutine shown in FIG. 17 is substantially identical to the subroutine in FIG. 12 executed in the first embodiment, the subroutine is explained by assigning reference numerals corresponding to those in the subroutine executed in the first embodiment. Namely, step S251c in the subroutine executed in step S200 in the third embodiment, for instance, corresponds to step S251 in the subroutine executed in step S200 in the first embodiment. In step S211c, the effective speed with which the route information has been downloaded is calculated. Namely, the effective speed with which the route information has been downloaded is calculated by dividing the size of the route information having been received from the distribution center 200 by the length of time spent downloading the route information.

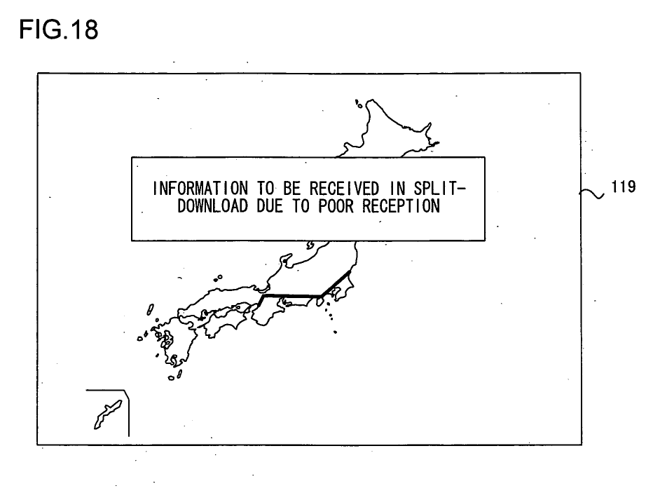

In step S213c, the effective speed having been calculated in step S211c is compared with the predetermined threshold value. If it is decided in step S213c that the effective speed is equal to or lower than the threshold value, the operation proceeds to step S215c to bring up a message indicating that due to poor reception, a split-download is to be executed on display at the display monitor 119, as shown in FIG. 18. Then, the operation proceeds to step S257c to transmit to the distribution center 200 a split-download request for receiving the yet-to-be received guide information through a split download. Since the operation executed in step S257c and subsequent steps is identical to the operation executed in step S257 and subsequent steps in the first embodiment, its explanation is omitted.

If it is decided in step S213c that the effective speed is not equal to or lower than the threshold value, the operation proceeds to step S251c to calculate the estimated download time for downloading the yet-to-be received guide information. Since the operation executed in step S251c and subsequent steps is identical to the operation executed in step S251 and subsequent steps in the first embodiment or in step S251b and subsequent steps in the second embodiment, its explanation is omitted.

The following advantage is achieved through the third embodiment. When the reception is poor, the risk of a communication failure occurring while a batch download is in progress to result in a repeated retransmission/reception is significant. In particular, the communication tends to become cut off readily if the recipient vehicle engaged in communication is moving. If the communication is cut off during a batch download, the information must be retransmitted/received from the beginning, and thus, the batch download will turn out to be more time-consuming than a split download. As described above, the vehicle-mounted information terminal achieved in the third embodiment is capable of making a decision as to whether or not to opt for a split-download of the yet-to-be received guide information from the distribution center 200 at the vehicle-mounted device 100 based upon the state of radio waves exchanged between the portable telephone 150 and the mobile communication network 250. Namely, if the reception is poor, the guide information being distributed is received through a split download. (3) As a result, the risk of an increased communication time due to a possible communication failure/retry that may occur during a batch download can be avoided, and the total length of time required for the download can be reduced.

While the decision as to whether or not the reception is poor is made based upon the effective speed with which the route information has been downloaded in the third embodiment described above, this decision may instead be made based upon the electrical field intensity of a signal received at the portable telephone 150.

### Fourth Embodiment

In the fourth embodiment, when a request for a route search is transmitted from the portable telephone 150 to the distribution center 200, a decision is made at the vehicle-mounted device 100 based upon the distance between the current vehicle position and the destination as to whether or not a request for a split-download of guide information should be requested. The following is an explanation of the fourth embodiment.

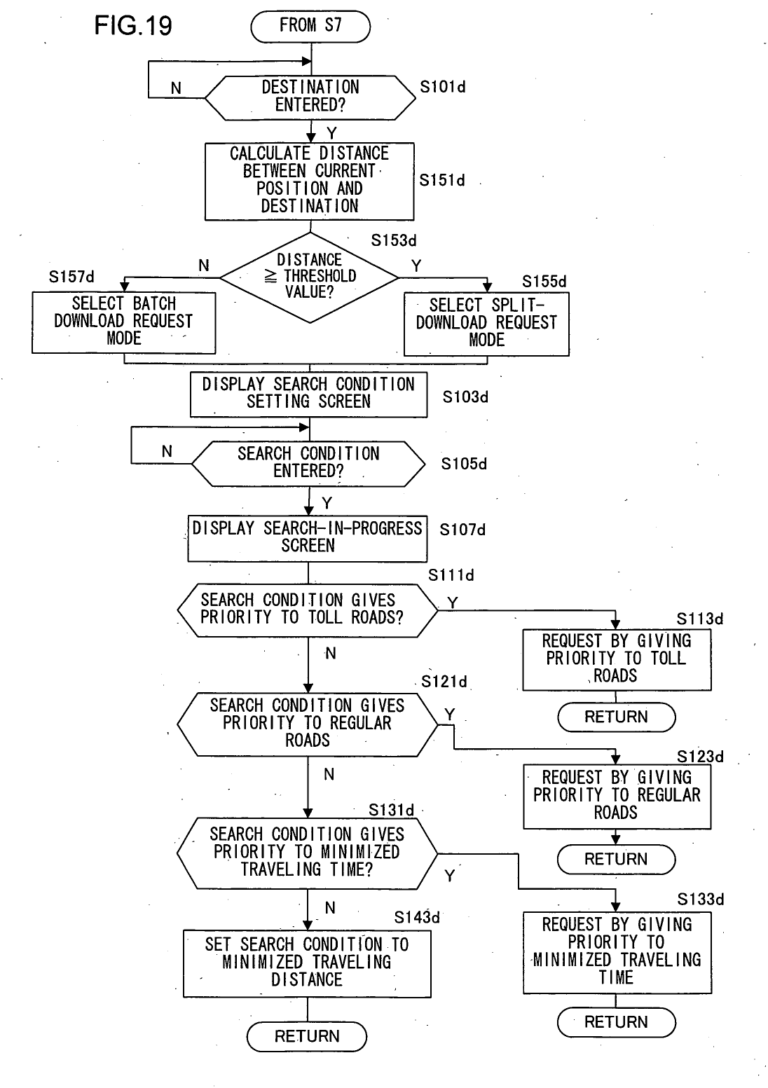

FIG. 19 presents a flowchart of the subroutine executed instep S100 in the fourth embodiment. As the current vehicle position is indicated at the display monitor 119 as shown in FIG. 6 in step S7 in the main routine shown in FIG. 5, the operation proceeds to step S100 to execute the subroutine. In step S101d, the operation waits in standby until a destination is set through a user operation. FIG. 8 shows a display brought up on the display monitor 119 when the destination is set, with the destination indicated as a cross point 402 of two lines running perpendicular to each other at the display monitor 119. If it is decided in step S101d that a destination has been set, the distance between the current vehicle position and the destination is calculated in step S151d. While the distance between the current vehicle position and the destination changes depending upon the route that is selected, the distance is calculated in this step as the length of a straight line connecting the vehicle position and the destination.

In step S153d, a decision is made as to whether or not the distance between the current vehicle position and the destination is equal to or greater than a predetermined threshold value. If it is decided in step S153d that the distance between the current vehicle position and the destination is equal to or greater than the predetermined threshold value, a split-download mode is set in the route search request from the vehicle-mounted device 100 so as to have the distribution center 200 transmit the route search results in installments in step S155d, and then the operation proceeds to step S103d. If, on the other hand, it is decided in step S153d that the distance between the current vehicle position and the destination is less than the predetermined threshold value, a batch download mode is set in the route search request from the vehicle-mounted device 100 so as to have the distribution center 200 transmit the route search results all at once in a batch in step S157d, and then the operation proceeds to step S103d. It is to be noted that the user may be allowed to select the download mode as in the first and second embodiments.

In step S103d, the route search condition setting screen in FIG. 9 is brought up on display. After judging in step S105d that the search condition has been set, the message indicating that the search is in progress, as shown in FIG. 8, is brought up on display at the display monitor 119, before the operation proceeds to step S111d. Upon deciding in step S111d that the search condition having been set by the user through steps S103d to 105d gives priority to toll roads, the operation proceeds to step S113d. In step S113d, the route search request indicating the current position, the destination and the search condition giving priority to toll roads is transmitted to the distribution center 200 in the download request mode having been determined through the processing in steps S153d through 157d, before the operation returns to the main routine to execute step S11 and subsequent steps in the main routine. Since the processing executed in the subroutine in FIG. 19 after making a decision in step S111d that the search condition having been set by the user in steps S103d through 105d does not give priority to toll roads is similar to the processing executed in step S121 and subsequent steps in the first embodiment, its explanation is omitted.

The information indicating the current vehicle position, the destination and the route search condition selected through the subroutine and the download request mode is thus transmitted to the distribution center together with the ID number to be used to identify the vehicle. The distribution center 200 then accesses the search•guide server 203 to execute a route calculation in step S700.

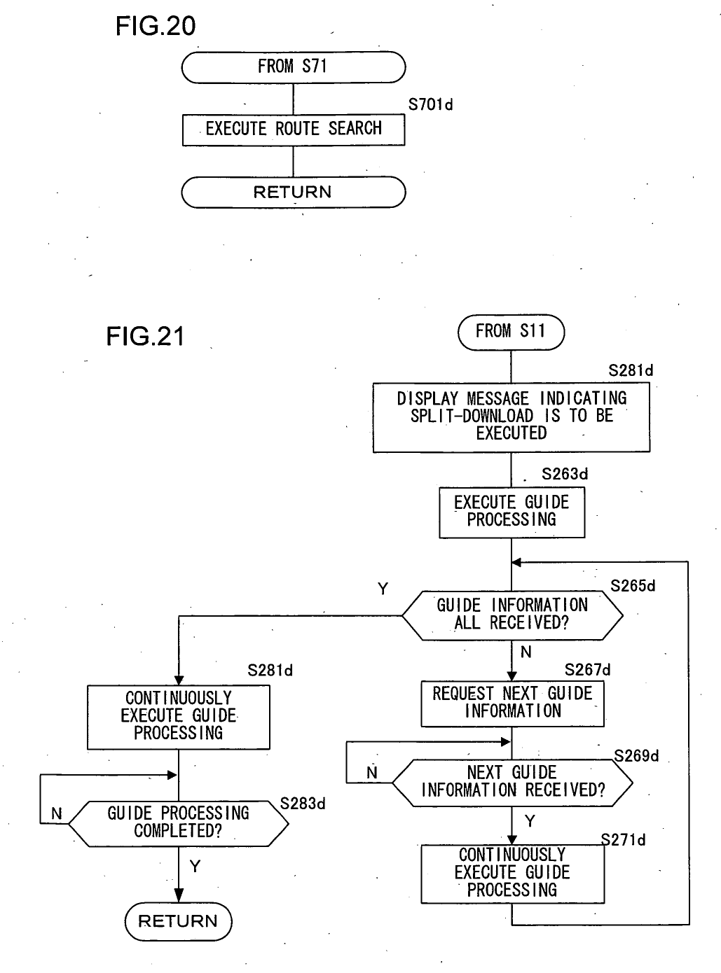

FIG. 20 shows the subroutine executed in step S700 in the fourth embodiment. As the route search request from the request receiving server 201 is received at the search•guide server 203 in step S71 in FIG. 5, the operation proceeds to step S700. In step S701d, a route search calculation is executed based upon the position information and the route search condition indicated in the information transmitted from the vehicle-mounted device 100, and then the operation returns to the main routine. Then, in step S73 in the main routine, the route information and the guide information obtained through the arithmetic operations executed in the subroutine in step S700 are transmitted to the request receiving server 201.

As explained earlier, the calculation results received from the search•guide server 203 are first transmitted to the customer DB server 204 by the request receiving server 201 in step S59, and then the operation proceeds to step S61. In step S61, the calculation results provided by the search•guide server 203 are transmitted in the download mode having been requested by the vehicle-mounted device 100. Namely, if a split-download has been requested by the vehicle-mounted device 100, the route information and part of the guide information are taken out from the results of calculations executed at the search•guide server 203 and are transmitted to the vehicle-mounted device 100. If, on the other hand, a batch download has been requested by the vehicle-mounted device 100, the results of the calculations executed at the search•guide server 203 are transmitted to the vehicle-mounted device 100 in a batch.

At the vehicle-mounted device 100, upon deciding in step S11 that the route information from the distribution center 200 has been received, the operation proceeds to execute the subroutine in step S200.

FIGS. 21 and 23 show the subroutine executed in step S200 in the fourth embodiment. FIG. 21 shows the subroutine executed in step S200 when the split-download mode has been selected, whereas FIG. 23 shows the subroutine executed in step S200 when the batch download mode has been selected. The subroutines shown in FIGS. 21 and 23 are now explained by using step numbers corresponding to the step numbers included in the subroutine executed in the first embodiment. Namely, step S251d in the subroutine executed in step S200 in the fourth embodiment, for instance, corresponds to step S251 in the subroutine executed in step S200 in the first embodiment.

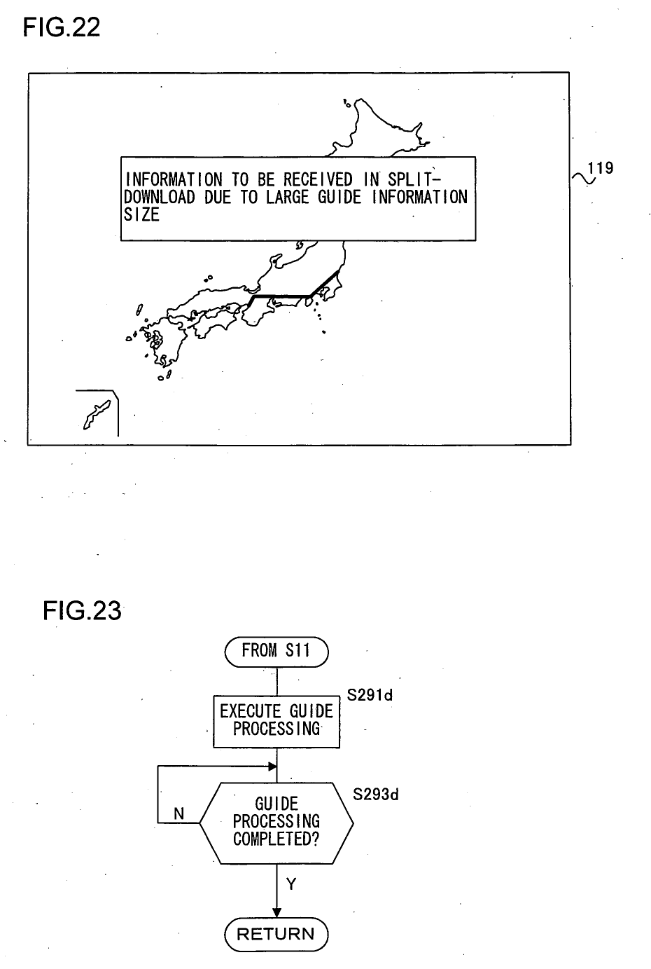

First, the subroutine shown in FIG. 21, which is executed in step S200 when the split-download mode has been selected, is explained. At the vehicle-mounted device 100, upon deciding in step S11 that the route information and guide information up to, for instance, the first guide point have been received from the distribution center 200, the operation proceeds to step S281d to bring up at the display monitor 119 a message indicating that a split-download is to be executed as shown in FIG. 22, and then the operation proceeds to step S263d to start guide processing based upon the guide information having been received. The operation executed in step S265d in which a decision is made as to whether or not the entire guide information has been received and subsequent steps is identical to the operation executed in step S265 and subsequent steps in the first embodiment, and for this reason, its explanation is omitted.

Next, the subroutine shown in FIG. 23, which is executed in step S200 when the batch download mode has been selected, is explained. At the vehicle-mounted device 100, upon deciding in step S11 that the route information and the guide information from the distribution center 200 have been received in their entirety, the operation proceeds to step S291d to start guide processing based upon the guide information having been received. In step S293d, the operation waits in standby for the completion of the guide processing. Upon deciding in step S293d that the guide processing has been completed, the operation returns to the main routine to end the main routine program.

The following advantage is achieved in the fourth embodiment. When the distance between the current vehicle position and the destination is large, the volume of the information that needs to be downloaded is bound to be large. If the communication fails while a batch download is in progress under these circumstances, the information will need to be retransmitted/received from scratch. As a result, the length of time required for the batch download may become greater than the length of time that would be spent downloading the same information in installments. As explained earlier, at the vehicle-mounted device 100 embodying the vehicle-mounted information terminal in the fourth embodiment, a decision can be made as to whether or not a split-download of the guide information should be requested based upon the distance between the current vehicle position and the destination when sending a route search request from the portable telephone 150 to the distribution center 200. Namely, if the distance between the current vehicle position and the destination is large, the guide information provided by the distribution center is received through a split download. By opting for a split-download, the risk of an increased communication time due to a possible communication failure/retry that may occur during a batch download can be avoided, and the total length of time required for the download can be reduced.

### Fifth Embodiment

In the fifth embodiment, when a route search request is transmitted from the portable telephone 150 to the distribution center 200, a decision is made at the vehicle-mounted device 100 as to whether or not to request a split-download of the guide information in correspondence to the specific type of portable telephone 150 connected to the vehicle-mounted device 100. Namely, depending upon whether or not the portable telephone 150 is capable of supporting high-speed communication, a decision is made at the vehicle-mounted device 100 as to whether or not to request a split-download of the guide information. The following is an explanation of the fifth embodiment.

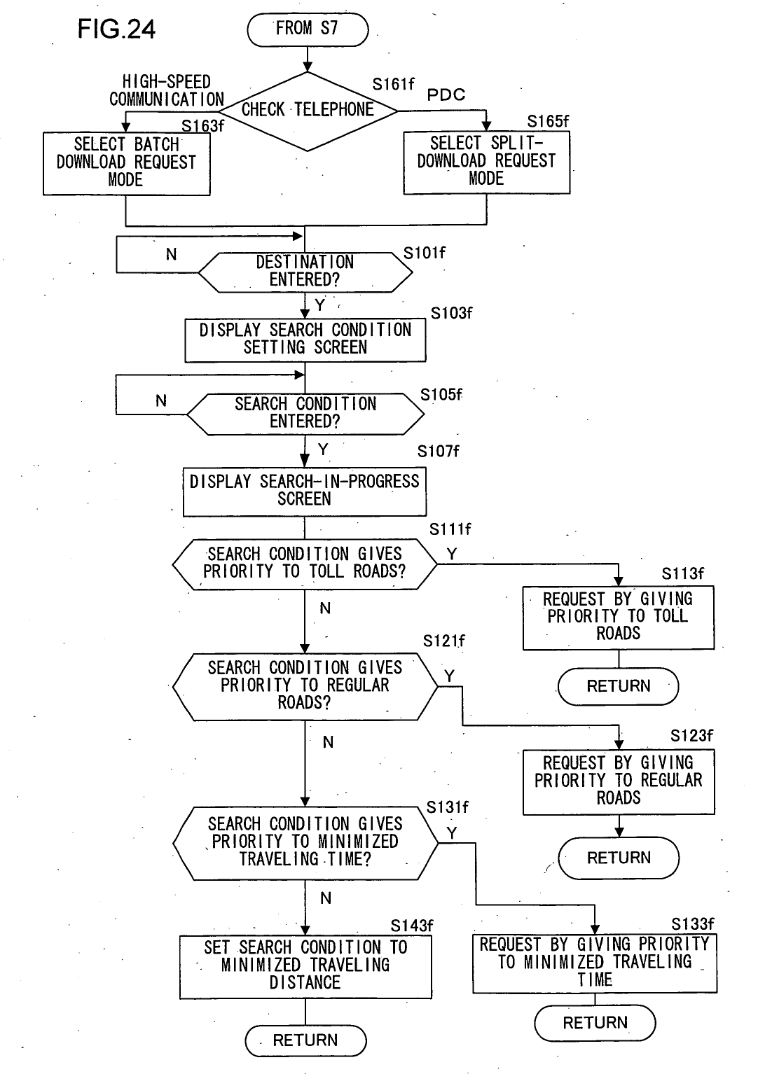

FIG. 24 presents a flowchart of the subroutine executed in step S100 in the fifth embodiment. As the current vehicle position is indicated at the display monitor 119 as shown in FIG. 6 in step S7 in the main routine shown in FIG. 5, the operation proceeds to step S100 to execute the subroutine. In step S161f, the type, i.e., the communication speed of the portable telephone 150 connected to the vehicle-mounted device 100 is determined. If it is decided in step S161f that the communication speed of the portable telephone 150 connected to the vehicle-mounted device 100 is equal to or higher than 28.8 kbps, the operation proceeds to step S163f to set the batch download mode in the route search request to be issued by the vehicle-mounted device 100 so as to have the distribution center 200 transmit the route search results in a batch. If, on the other hand, it is decided in step S161f that the communication speed of the portable telephone 150 connected to the vehicle-mounted device 100 is not equal to or higher than 28.8 kbps, the operation proceeds to step S165f to set the split-download mode in the route search request to be output from the vehicle-mounted device 100 so as to have the distribution center 200 transmit the route search results in installments.

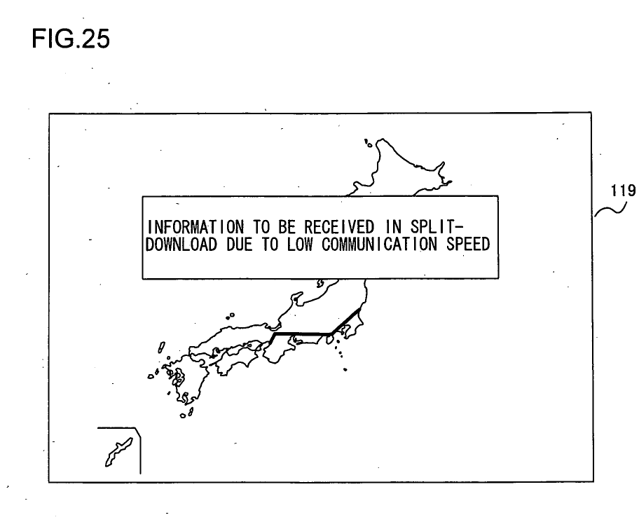

Since the processing executed in step S101f and subsequent steps in the subroutine in FIG. 24 is similar to the processing executed in step S101d and subsequent steps in the subroutine in the fourth embodiment, its explanation is omitted. In addition, since the operation at the distribution center 200 executed after the vehicle-mounted device 100 transmits the route search request to the distribution center 200 in step S100 and the operation at the vehicle-mounted device 100 having received the information are also similar to those in the fourth embodiment, their explanation is omitted, as well. However, a message indicating that a split-download is to be executed is brought up on display at the display monitor 119 as shown in FIG. 25 in step S281d in FIG. 21.

At the vehicle-mounted device 100 embodying the vehicle-mounted information terminal in the fifth embodiment, a decision can be made as to whether or not to request a split-download of the guide information based upon the type of the portable telephone 150 connected to the vehicle-mounted device 100. Namely, if the portable telephone 150 is capable of supporting high-speed communication, the guide information is received in a batch download, whereas if the portable telephone does not support high-speed communication, the guide information provided by the distribution center is received through a split download. As a result, the communication can be completed quickly through a batch download if the portable telephone connected to the vehicle-mounted device 150 supports high-speed communication. If, on the other hand, the portable telephone connected to the vehicle-mounted device 150 does not have high-speed communication capability, the information is received through a split-download so as to eliminate the risk of an increase in the communication time caused by a communication failure/retry which may occur during a batch download and thus to reduce the overall download time.

### Sixth Embodiment

In the sixth embodiment, when a route search request for the distribution center 200 to search for a route to a destination is also transmitted from the portable telephone 150, information indicating the destination and a plurality of waypoints is transmitted and the distribution center 200 is requested to transmit both the recommended route information and the guide information resulting from the route search calculation executed at the distribution center 200 in correspondence to each waypoint. Namely, the route search calculation results corresponding to the part of the route from the current position to the first waypoint are initially received, the route search results corresponding to the part of the route to the next waypoint are received as the vehicle reaches the area near the first waypoint and the subsequent route guidance is provided based upon the route search results received in sequence. The operation executed in the sixth embodiment is now explained.

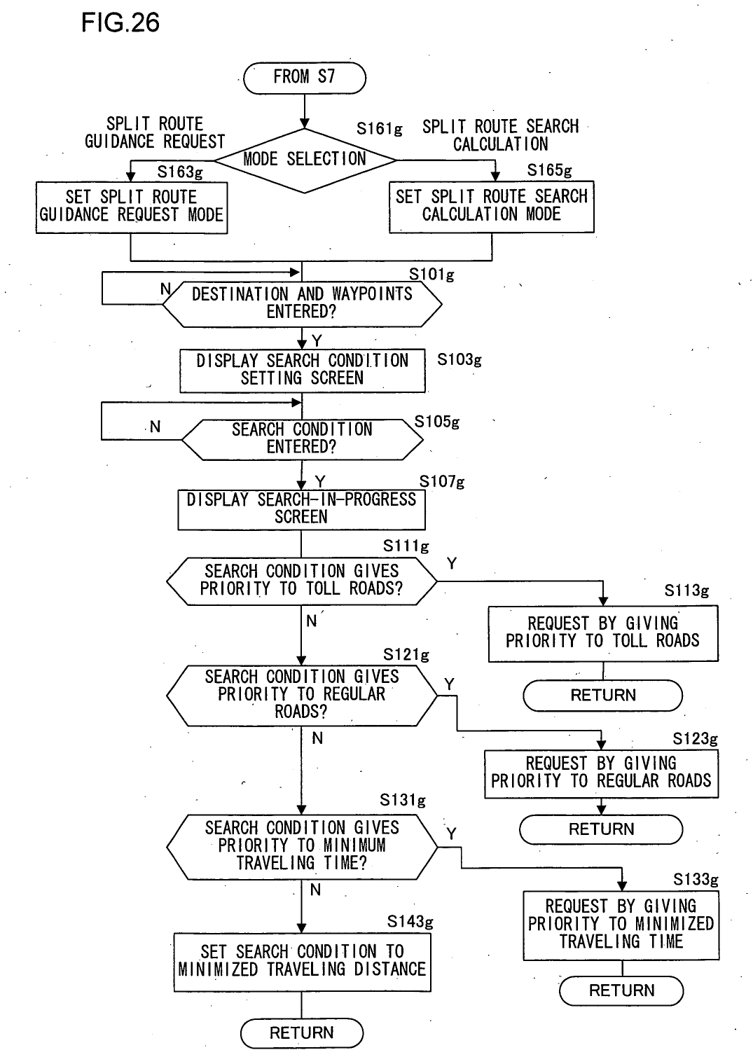

FIG. 26 shows the subroutine executed in step S100 in the sixth embodiment. As the current vehicle position is indicated at the display monitor 119 as shown in FIG. 6 in step S7 of the main routine shown in FIG. 5, the operation proceeds to step S100 to execute the subroutine. In step S161g, a request mode to indicate how the recommended route information and the guide information resulting from the route search calculation executed at the distribution center 200 are to be received is selected.

The mode selected in step S161g is either a split route guidance request mode or a split route search calculation mode. If the split route guidance request mode is selected, the vehicle-mounted device 100 and the distribution center 200 engage in operation as described below.
(1) The distribution center 200 executes a route search calculation to determine the route to be taken from the start point (the subject vehicle position) to the destination based upon the information received from the vehicle-mounted device 100 and stores in memory the calculation results.
(2) The vehicle-mounted device 100 receives both the recommended route information and the guide information resulting from the route search calculation executed at the distribution center 200 in correspondence to each block of the route cut off at a waypoint. First, the calculation results corresponding to the block extending from the start point to the first waypoint are received. The route guidance is started based upon the received calculation results, and as the vehicle approaches the first waypoint, a request for the distribution center 202 to transmit the route search calculation results corresponding to the block extending to the next waypoint, which are stored at the distribution center 200, is automatically issued. The route search calculation results are thus received in sequence until the results corresponding to the last block extending to the destination are received.

The vehicle-mounted device 100 and the distribution center 200 engage in operation as described below when the split route search calculation mode is selected.
(1) The distribution center 200 executes a route search calculation to determine the route from the start point (the subject vehicle position) to the first waypoint based upon the information received from the vehicle-mounted device 100 and stores in memory the calculation results.
(2) The vehicle-mounted device 100 receives both the recommended route information and the guide information resulting from the route search calculation having been executed to determine the route to the first waypoint. Then, the vehicle-mounted device starts the route guidance, and as the vehicle approaches the first waypoint, the driver is prompted to indicate whether or not to search for the route to the next waypoint. If the driver indicates that a route search is to be executed to determine the route to the next waypoint, a request for the execution of the route search calculation up to the next waypoint and the transmission of the calculation results is issued to the distribution center 200. Thus, the route search calculation request is issued in correspondence to each waypoint and the calculation results are received in sequence.

Namely, unlike in the split route guidance request mode, the distribution center 200 does not execute a route search calculation for the entire route but instead it executes a route search calculation for the block extending from the current vehicle position to the next waypoint only and transmits the calculation results to the vehicle-mounted device 100 in the split route search calculation mode.

If it is decided in step S161g that the selected request mode is the split route guidance request mode, the operation proceeds to step S163g to set the split route guidance request mode before proceeding to step S101g. If it is decided in step S161g that the selected request mode is the split route search calculation mode, the operation proceeds to step S165g to set the split route search calculation mode before proceeding to step S101g. Then, in step S101g, the operation waits in standby for the destination and the waypoints to be set through user operation. It is to be noted that if no waypoint is set, the calculation is executed by designating the first waypoint to be detailed later as the destination. Upon judging in step S101g that the destination and the waypoints have been set, the operation proceeds to step S103g. Since the processing executed in step S103g and subsequent steps in the subroutine in FIG. 26 is similar to that executed in step S103d and subsequent steps in the subroutine in the fourth embodiment, its explanation is omitted.

The information indicating the current vehicle position and the destination, the waypoints, the route search condition and the request mode selected through the subroutine, is transmitted to the distribution center 200 together with the ID number used to identify the vehicle. As explained earlier, the distribution center 200 accesses the search•guide server 203 to execute the route search calculation. The calculation results are transmitted to the vehicle-mounted device 100 via the request receiving server 201.

While the processing executed at the distribution center 200 is not explained in detail, it may be summarized as follows. If the split route guidance request mode has been selected at the vehicle-mounted device 100, the information transmitted from the request receiving server 201 in step S61 in FIG. 5 includes the recommended route information and the guide information for the block extending to the first waypoint, which constitute part of the results of the route search calculation executed to determine the route to the destination. In addition, the information transmitted from the request receiving server 201 to the vehicle-mounted device 100 in step S65 taken out from the results of the route search calculation having been executed to determine the route to the destination, includes the recommended route information and the guide information for the block extending to the next waypoint or the destination beyond the waypoint in correspondence to which information has been transmitted to the vehicle-mounted device 100 most recently.

If the split route search calculation mode has been selected at the vehicle-mounted device 100, the information transmitted from the request receiving server 201 to the vehicle-mounted device 100 in step S61 in FIG. 5 includes the recommended route information and the guide information indicated by the results of the route search calculation having been executed to determine the route to the first waypoint. Subsequently, each time a route search calculation request transmitted through the subroutine executed at the vehicle-mounted device 100 in step S200 as described later is received at the distribution center 200, a route search calculation is executed to determine the route to the next waypoint or the destination beyond the waypoint in correspondence to which information has been transmitted to the vehicle-mounted device 100 most recently and the recommended route information and the guide information resulting from the route search calculation are transmitted to the vehicle-mounted device 100.

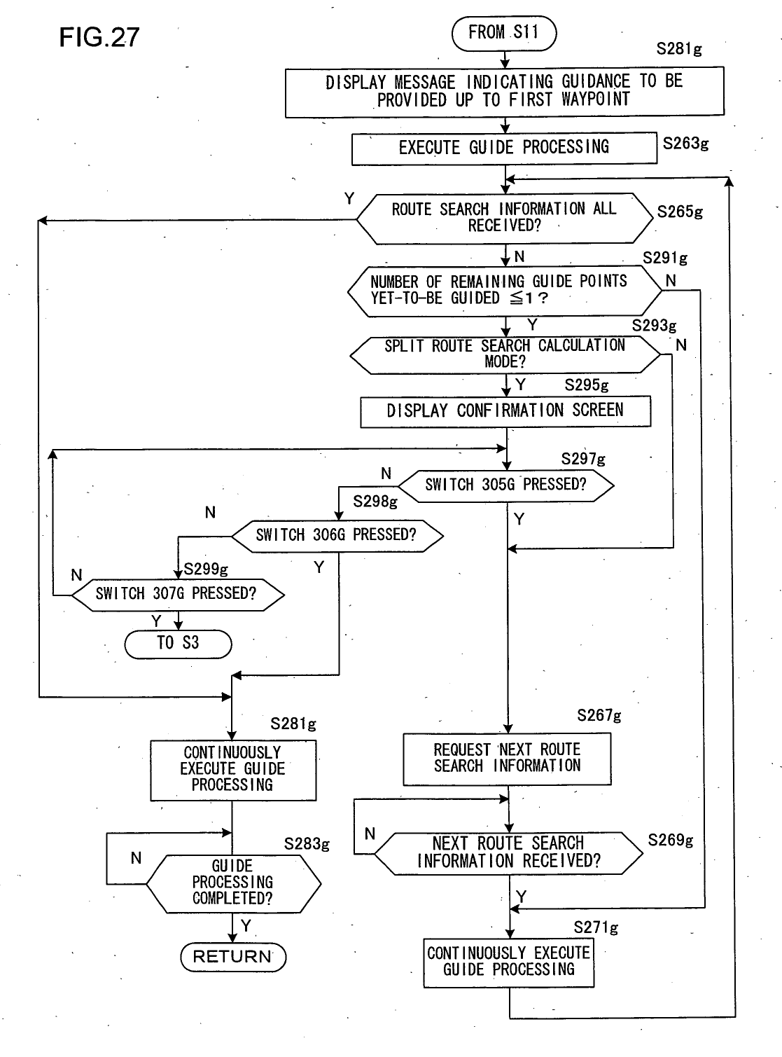

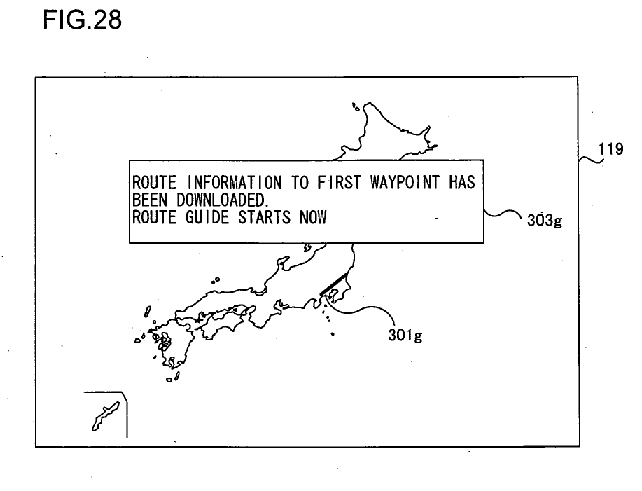

FIG. 27 shows the subroutine executed in step S200 in the sixth embodiment. At the vehicle-mounted device 100, upon deciding in step S11 in FIG. 5 that the recommended route information and the guide information corresponding to the block extending to the first waypoint, i.e., the route search information corresponding to the block up to the first waypoint, have been received from the distribution center 200, the operation proceeds to step S281g to bring up a message indicating that the route guidance up to the first waypoint is to be provided at the display monitor 119, as shown in FIG. 28, and then the operation proceeds to step S263g. FIG. 28 shows a display brought up at the display monitor 119, which includes a dialogue 303g indicating that route guidance is to start and a recommended route 301g to the first waypoint indicated by the route search information having been received. In step S263g, guide processing starts based upon the received route search information.

In step S265g, a decision is made as to all the route search information including the block extending to the final destination has been received. If a negative decision is made in step S265g, the operation proceeds to step S291g to make a decision as to whether or not the number of guide points for which guidance has not yet been provided, contained in the route search information having been received, is equal to or smaller than one. If an affirmative decision is made in step S291g, the operation proceeds to step S293g to make a decision as to whether or not the split route search calculation mode has been selected.

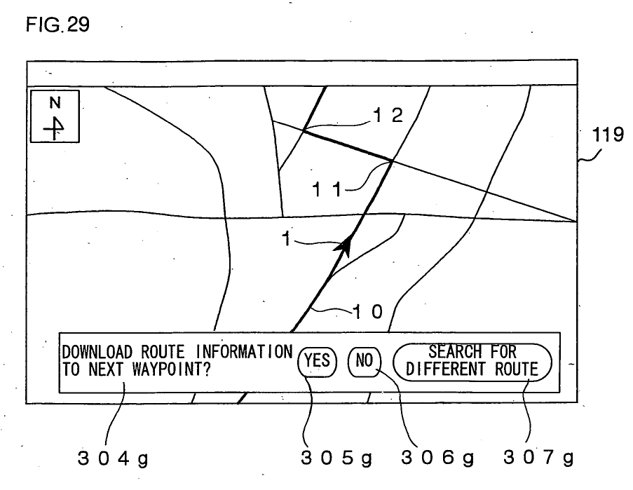

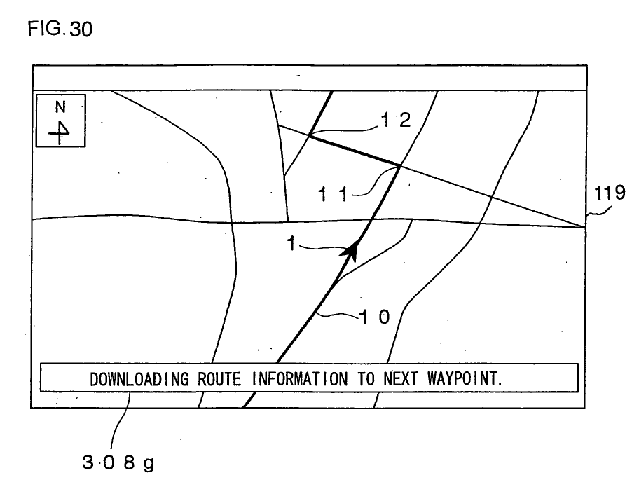

If an affirmative decision is made in step S293g, i.e., if it is judged that the split route search calculation mode has been selected, the operation proceeds to step S295g. In step S295g, a dialogue 304g asking the user whether or not he wishes to receive the next set of route search information is brought up on display at the display monitor 119 as shown in FIG. 29, and thus, the driver is prompted to indicate whether or not he wishes to issue a request that the distribution center 200 execute the route search calculation up to the next waypoint and transmit the calculation results. A subject vehicle position mark 1 in FIG. 29 indicates that the vehicle is currently traveling along the recommended route 10 toward an intersection 11. Guide information such as “turn left at the second intersection ahead” has already been provided with regard to the intersection 11, whereas no guide information has yet been provided with regard to an intersection 12 beyond the intersection 11. In addition, touch panel switches 305g to 307g through which the user is able to indicate whether or not to receive the next set of route search information are displayed as part of the dialogue 304g.

If the switch 305g is pressed and accordingly, an affirmative decision is made in step S297g, i.e., if the user is judged to wish to issue a request that the distribution center 200 execute a route search calculation for the next waypoint and transmit the calculation results, the operation proceeds to step S267g. Instep S267g, a request for the route search calculation up to the next waypoint and the transmission of the calculation results is transmitted to the distribution center 200, before the operation proceeds to step S269g. Since the processing executed in step S269g and subsequent steps is similar to that executed in step S269d and subsequent steps in the subroutine in the fourth embodiment, its explanation is omitted.

If the switch 305g is not pressed and accordingly a negative decision is made in step S297g, the operation proceeds to step S298g to make a decision as to whether or not the switch 306g has been pressed. If it is decided in step S298g that the switch 306g has been pressed and an affirmative decision is made accordingly, i.e., if it is judged that the user does not wish to request the execution of the route search calculation up to the next waypoint or the transmission of the calculation results, the operation proceeds to step S281g. If the switch 306g has not been pressed and a negative decision is made in step S298g, on the other hand, the operation proceeds to step S299g to make a decision as to whether or not the switch 307g has been pressed. If the switch 307g has been pressed and an affirmative decision is made in step S299g, i.e., if it is decided that a search for another route is to be executed, this subroutine ends and the operation returns to step S3 in the main routine. If the switch 307g has not been pressed and a negative decision is made in step S299g, the operation returns to step S297g.

If an affirmative decision is made in step S265g or an affirmative decision is made in step S298g, the operation proceeds to step S281g to continuously execute the guide processing. Then, the operation waits in standby for the guide processing to end in step S283g. If an affirmative decision is made in step S283g, this subroutine ends.

If a negative decision is made in step S291g, the operation proceeds to step S271g to continuously execute the guide processing, and then the operation returns to step S265g.

If a negative decision is made in step S293g, i.e., if it is judged that the split route guidance request mode has been selected, the operation proceeds to step S267g to transmit a request for the route search information corresponding to the block extending to the next waypoint, and then the operation proceeds to step S269g.

The following advantages are achieved in the sixth embodiment described above.
(1) If the entire route search information for the route to the final destination is received at an early stage after the vehicle starts toward the final destination and then the user decides to take a different route part way through, the route search information for the route beyond the point at which the route is changed and the corresponding communication cost will be wasted. In contrast, by receiving the route search information in smaller installments as in the sixth embodiment, the user does not need to incur the communication cost for downloading the route search calculation results for the remainder of the route if the driver changes his mind and decides to travel on a different route.
(2) When the split route guidance request mode has been selected, the vehicle-mounted device 100 requests the route search calculation results corresponding to the block extending to the next waypoint from the distribution center 200 as the subject vehicle approaches the immediate waypoint and is able to continuously provide the route guidance by using the received route search calculation results. Thus, another advantage is achieved in that the vehicle is guided smoothly without inconveniencing the driver, in addition to the advantage described above.
(3) When the split route search calculation mode has been selected, the vehicle-mounted device 100 prompts the driver to indicate whether or not to request the route search calculation results for the block extending to the next waypoint from the distribution center 200 as the subject vehicle approaches the immediate waypoint. The driver, thinking that he will probably want to take another route near the waypoint, may select this mode when departing for the destination. In the split route search calculation mode, the driver is allowed to choose to request the route search calculation results for the block extending to the next waypoint from the distribution center 200 or to request a search of a different route by the distribution center 200. As a result, the user does not need to incur the communication cost for downloading the route search calculation results for the block to the next waypoint that would be automatically received in the split route guidance request mode and, at the same time, a higher level of convenience for the driver is assured. In addition, since no unnecessary arithmetic operation is executed, the onus on the distribution center 200 is reduced as well.

### Seventh Embodiment

In the seventh embodiment, when issuing a request for the transmission of remaining guide information to be received in an installment to the distribution center 200, information indicating the average vehicle speed per hour having been collected up to the time point at which the request is transmitted in correspondence to each road type, too, is transmitted to the distribution center 200. At the distribution center 200, guide information to be transmitted to the vehicle-mounted device 100 is extracted based upon the average speed per hour information transmitted from the vehicle-mounted device 100 and transmits the extracted guide information to the vehicle-mounted device 100. The operation executed in the seventh embodiment is now explained. It is to be noted that the following explanation focuses on the operation unique to the seventh embodiment and a full explanation of the seventh embodiment, which is otherwise identical to the first embodiment, is not provided.

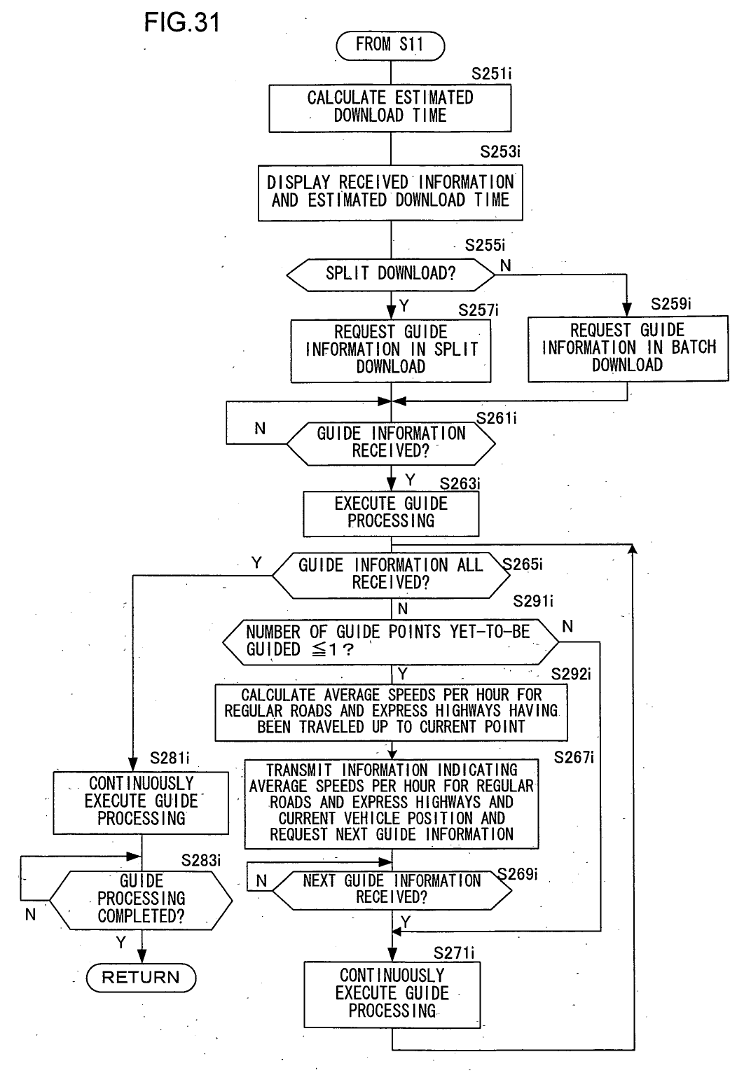

FIG. 31 shows the subroutine executed in step S200 in the seventh embodiment. At the vehicle-mounted device 100, upon deciding in step S11 in FIG. 5 that the route information and the guide information for the block extending to the first guide have been received from the distribution center 200, the estimated download time for downloading the entire guide information is calculated in step S251i. Since the subsequent processing executed in steps S251i through S265i is identical to the processing executed in the first embodiment in steps S251 through S265 as explained in reference to FIG. 12, its explanation is omitted.

In step S265i, a decision is made as to whether or not the entire guide information has been received. If a negative decision is made in step S265i, the operation proceeds to step S291i to make a decision as to whether or not the number of guide points for which guidance is yet-to-be provided is equal to or smaller than one. If a negative decision is made in step S291i, the operation proceeds to step S271i to continuously execute the guide processing before the operation returns to step S265i. If, on the other hand, an affirmative decision is made in step S291i, the operation proceeds to step S292i to calculate the average speeds per hour respectively for regular roads and express highways having been traveled up to the current time point, and then the operation proceeds to step S267i. In step S267i, a request for the next set of guide information is transmitted to the distribution center 200 together with information indicating the average speeds per hour for the regular roads and the express highways having been calculated in step S292i, and then the operation proceeds to step S269i. Since the processing executed in step S269i and subsequent steps is similar to the processing executed in step S269 and subsequent steps in the subroutine in the first embodiment, its explanation is omitted.

While the operation proceeds to step S281i after making an affirmative decision in step S265i, the operation executed in step S281i and subsequent steps is identical to that executed in step S281 and subsequent steps in the first embodiment and, for this reason, its explanation is omitted.

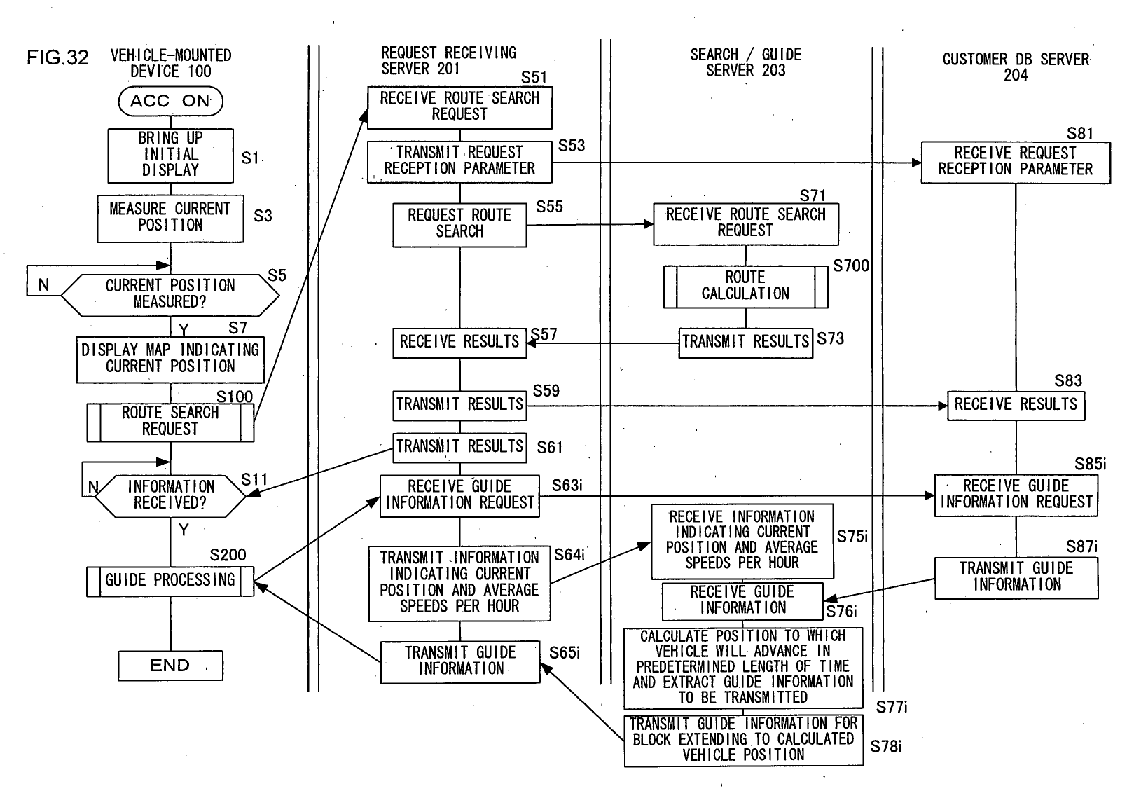

FIG. 32 presents an integrated flowchart of the operations executed at the vehicle-mounted device 100, the request receiving server 201, the search•guide server 203 and the customer DB server 204 in the seventh embodiment. It is to be noted that since the operation executed at the vehicle-mounted device 100 in steps S1 through S11, the operation executed at the request receiving server 201 in steps S51 through S61, the operation executed at the search•guide server 203 in steps S71 through S73 and the operation executed at the customer DB server 204 in steps S81 through S83 are identical to the corresponding operations executed in the first embodiment, their explanation is omitted.

In response to a distribution request received from the vehicle-mounted device 100 instep S63i, the request receiving server 201 issues a request that the guide information stored in the customer DB server 204 be transmitted to the search•guide server 203, before proceeding to step S64i. In step S64i, the request receiving server transmits the information indicating the average speeds per hour for the regular roads and the express highways and the current vehicle position having been received in step S63i from the vehicle-mounted device 100 to the search•guide server 203. In step S65i, it transmits the guide information received from the search•guide server 203 as explained later to the vehicle-mounted device 100.

At the customer DB server 204, in response to the request having been received from the request receiving server 201 in step S85i, i.e., in response to the distribution request issued from the vehicle-mounted device 100, the guide information for the entire route having been stored in step S83 is transmitted to the search•guide server 203 in step S87i.

At the search•guide server 203, the position to which the vehicle will have traveled after a predetermined length of time (hereafter referred to as the calculated vehicle position) is ascertained through an arithmetic operation and the guide information to be used to guide the vehicle to the calculated vehicle position is extracted in step S77i based upon the information indicating the average speeds per hour and the current vehicle position having been received from the vehicle-mounted device 100 in step S75i and the entire guide information having been received in step S76i. In step S78i, the search•guide server transmits the results of the arithmetic operation executed in step S77i, i.e., the guide information for the block extending to the calculated vehicle position, to the request receiving server 201.

The following advantages are achieved in the seventh embodiment.
(1) Based upon the past average speed per hour information transmitted thereto, the distribution center 200 is able to estimate the point at which the vehicle equipped with the vehicle-mounted device 100 will be located after a predetermined length of time and set the guide information for the block extending to the particular point as the guide information to be transmitted next. As a result, a guide information request is generated from the vehicle-mounted device 100 over substantially constant time intervals. Since this allows the driver to anticipate when the next guide information request will be generated, he is able to avoid unnecessarily incurring the communication cost for downloading the guide information that has not been received yet, should he change his mind and decide to travel on a different route.
(2) Since the average speeds per hour for regular roads and express highways are both calculated and thus the average speed per hour closely reflecting the actual traveling state can be ascertained, the calculated vehicle position can be determined with a high level of accuracy so as to allow the correct volume of information to be set to be transmitted to the vehicle-mounted device 100.

### Variations of the First Through Seventh Embodiments

While the user is prompted to indicate whether or not to receive information through a split-download in the display screen at the vehicle-mounted device 100 that has received the route information having attached thereto information indicating the guide information size or the route information having attached thereto information indicating the number of guidance-requiring intersections in the first, second and seventh embodiments, the decision as to whether or not to opt for a split-download may be automatically made by the vehicle-mounted device 100.

For instance, after calculating the estimated download time for the yet-to-be received guide information in step S251 in the first embodiment, the estimated download time may be compared with a predetermined threshold value. Then, the download mode indicated in the route search request from the vehicle-mounted device 100 may be set so as to receive the guide information through a batch download if the estimated download time is smaller than the threshold value and to receive the guide information through a split-download if the estimated download time is equal to or greater than the threshold value.

In a variation of the second embodiment, the decision as to whether or not to select a split-download may be made by comparing the estimated download time with a predetermined threshold value as in the variation of the first embodiment, or the decision as to whether or not to select a split-download may be made in a similar manner but based upon the number of guidance-requiring intersections instead of the estimated download time.

These variations allow the vehicle-mounted device 100 to determine the optimal download method without involving the user to relieve the user of the onus of decision-making. In addition, once the destination and the search condition are set, the user does not need to perform a further operation at the vehicle-mounted device 100 and the user having started driving the vehicle, for instance, is able to focus on driving for better safety.

While the quality of reception is judged at the vehicle-mounted device 100 in the third embodiment, the reception may be judged at the distribution center 200, instead.

While the decision as to whether or not to request a split-download is made based upon the distance between the current vehicle position and the destination in the fourth embodiment, the decision may be made by taking into consideration the search condition, as well. For instance, even when the distance between the current vehicle position and the destination is very large, the number of guidance-requiring intersections on the route determined under the search condition giving priority to express highway traveling is bound to be small and the data size of the guide information, too, will be small. In such a case, the guide information may be downloaded in a batch.

While the decision as to whether or not to request a split-download is made in the fifth embodiment by as certaining whether or not the communication speed is equal to or higher than 28.8 kbps, a communication speed value other than this may be used in the decision-making.

In the sixth embodiment, as the subject vehicle approaches a given waypoint, the vehicle-mounted device 100 automatically issues a request for the route search calculation results corresponding to the block extending to the next waypoint to the distribution center 200 in the split route guidance request mode. In addition, as the subject vehicle approaches a waypoint, the vehicle-mounted device 100 prompts the driver to indicate whether or not to transmit to the distribution center 200 a request for the route search calculation results corresponding to the block extending to the next waypoint. However, the present invention is not limited to this example. As the subject vehicle approaches a waypoint, the vehicle-mounted device 100 mode may prompt the driver to indicate whether or not to transmit to the distribution center 200 a request for the route search calculation results corresponding to the block extending to the next waypoint. In addition, as the subject vehicle approaches a waypoint, the vehicle-mounted device 100 may automatically transmit to the distribution center 200a request for the route search calculation results corresponding to the block extending to the next waypoint. Furthermore, the route search calculation results for the block extending to the next waypoint may be automatically requested in both modes, or the route search calculation results for the block extending to the next waypoint may be requested only after verifying with the driver in both modes.

While the guide information extracted based upon the information indicating the actual average speeds corresponding to individual types of roads having been traveled, which has been transmitted from the vehicle-mounted device 100, is transmitted from the distribution center 200 in the seventh embodiment, guide information extracted based upon average speeds corresponding to different types of roads which are set in advance at the distribution center 200 may instead be transmitted from the distribution center 200. The range of guide information to be transmitted may be determined by taking into consideration the traffic conditions on the recommended route. Namely, the distribution center 200 may obtain road state data managed by the Road Administration Department in individual regions to ascertain the average speed along the recommended route with better accuracy, and the size of the guide information to be transmitted may be determined based upon the average speed thus ascertained. It is to be noted that the present invention is not limited to this example. As in the sixth embodiment, both the recommended route information and the guide information, i.e., the route search information, may be transmitted over the range determined in correspondence to the average speed.

While the information initially transmitted from the distribution center 200 for a split-download only contains the route information or the route information having attached thereto information indicating the data size of the guide information or information indicating the number of guidance-requiring intersections in the first to fifth embodiments, the seventh embodiment and the variations of embodiments described above, a small volume of the guide information itself may also be transmitted. For instance, through the route calculation executed in step S700 at the search•guide server 203, guide information for a block extending to the first guidance-requiring intersection distanced from the current position by a value larger than a predetermined threshold value may be extracted. Then, the information initially transmitted to the vehicle-mounted device 100 may include the route information and the guide information thus extracted. In addition, if a route search request giving priority to express highway traveling has been issued from the vehicle-mounted device 100 and there is an entrance to an interchange at a point closer to the current position than the first guidance-requiring intersection distanced from the current position by a value larger than the threshold value, the information initially transmitted to the vehicle-mounted device 100 may include the route information and guide information corresponding to the block extending to the interchange entrance. By adopting this variation, in which the vehicle-mounted device 100 receives the guide information over a certain distance together with the route information once the destination and the search condition are set, the route guide can be started immediately.

While the decision as to whether or not information is to be received in a split-download is made by the user, the vehicle-mounted device 100 or the distribution center 200 in the first through fifth embodiments, the seventh embodiment and the variations of embodiments described above, the user may set the vehicle-mounted device 100 for a split-download in advance.

While the vehicle-mounted device 100 issues a request for the distribution center 200 to distribute the next installment of guide information for a split-download when the reception of the preceding installment of guide information is completed in the first through fifth embodiments and the variations of embodiments explained above, the distribution request may not be issued by the vehicle-mounted device 100 immediately after receiving the preceding installment of guide information. For instance, the distribution request may be issued immediately after the vehicle has traveled through the last guidance-requiring intersection included in the guide information having already been received. Alternatively, the distribution request may be issued when there is only one remaining guide point for which guidance is yet-to-be provided, as in the sixth and seventh embodiments. Furthermore, in the sixth and seventh embodiments and the variations thereof, the distribution request may be issued immediately after the vehicle has passed through the last guide point included in the route search information having already been received.

While the customer DB server 204 splits the guide information in correspondence to individual guidance-requiring intersections or the customer DB server 204 splits the guide information so that a single unit of split guide information corresponds to a plurality of guidance-requiring intersections if the distances between the individual guidance-requiring intersections are short in the first through fifth embodiments and the variations of the embodiments described above, the present invention is not limited to this example. The guide information may be divided in units each corresponding to a waypoint present between the start point and the destination, instead.

The individual embodiments and the variations thereof described above may be adopted in conjunction with one another.

In addition, the information transmitted from the distribution center 200 in the embodiments and the variations thereof described above is not limited to the route information and the guide information. For instance, real-time information such as weather information around the current vehicle position and the destination, sale information indicating sale prices at stores, information indicating the cherry blossom status or the autumn color status at scenic points, information indicating crowd sizes at tourist attractions and natural disaster information may be transmitted. In addition, urgent information such as natural disaster information may be transmitted from the distribution center 200 and a message indicating that urgent information has been received may be brought up on display at the display monitor 119 of the vehicle-mounted device 100 without a request from the vehicle-mounted device 100.

### INDUSTRIAL APPLICABILITY

While the present invention is adopted in a vehicle-mounted car navigation device in the embodiments described above, the present invention may also be adopted in a portable navigation device. In addition, the present invention may be adopted in information terminals with communication capabilities used for various purposes as well as in navigation devices. AS long as the features characterizing the present invention are not compromised, the present invention is in no way restricted to the structures adopted in the embodiments described above.

1.-15. (canceled)

16. A route guidance method for providing route guidance by exchanging information related to a recommended route from a start point to a destination between an information terminal and an information distribution center, comprising in sequence:
(a) a step in which the information terminal transmits information indicating the start point and the destination to the information distribution center;
(b) a step in which the information distribution center obtains route guide information for a route from the start point to the destination through a search calculation;
(c) a step in which when a state of communication between the information terminal and the information distribution center is poor, the information distribution center splits results of the search calculation and transmits the search calculation results to the information terminal in installments; and
(d) a step in which when the search calculation results are transmitted in installments, the information terminal starts the route guidance upon receiving, at least, search calculation results corresponding to an area near the start point.

17. A route guidance method for providing route guidance by engaging an information terminal that transmits information indicating a start point and a destination to an information distribution center and the information distribution center that obtains through a search calculation route guide information for a route from the start point to the destination, splits results of the search calculation and transmits the search calculation results to the information terminal in installments when a predetermined condition exists, comprising in sequence:
(a) a step in which a user is informed of an estimated download time for downloading the search calculation results, determined based upon a physical quantity indicating a size of the search calculation results;
(b) a step in which the information terminal transmits to the information distribution center information indicating an instruction by the user that the information distribution center splits the search calculation results and transmits the search calculation results in installments;
(c) a step in which upon receiving the information indicating the instruction by the user that the search calculation results be split and transmitted in installments, the information distribution center extracts search calculation results corresponding to an area near the start point from the search calculation results and transmits the extracted search calculation results; and
(d) a step in which upon receiving the search calculation results corresponding to the area near the start point, the information terminal starts the route guidance.

18. A route guidance method according to claim 17, wherein:
the search calculation results include route information of the route from the start point to the destination and guide information used to indicate an advancing direction and the like at each guide point on the route.

19. A route guidance method according to claim 18, wherein:
the search calculation results corresponding to the area near the start point include at least guide information for a block extending from the start point to a next guide point.

20. A route guidance method according to claim 17, wherein:
the physical quantity indicates a data size of the guide information or a number of guide points contained in the guide information.

21. A route guidance method according to claim 17, wherein:
after starting the route guidance, the information terminal transmits to the information distribution center a request for remaining guide information.

22. A route guidance method according to claim 21, wherein:
the information terminal transmits to the information distribution center a request that the remaining guide information be distributed in units each corresponding to a guide point; and
each time the request is received, the information distribution center transmits guide information extracted in a unit corresponding to a guide point to the information terminal.

23. A route guidance method for providing route guidance by exchanging information related to a recommended route from a start point to a destination between an information terminal and an information distribution center, comprising in sequence:
(a) a step in which the information terminal transmits information indicating the start point and the destination to the information distribution center;
(b) a step in which the information distribution center obtains route guide information for a route from the start point to the destination through a search calculation;
(c) a step in which when a distance between the start point and the destination is equal to or greater than a predetermined value, the information distribution center splits results of the search calculation and transmits the search calculation results to the information terminal in installments; and
(d) a step in which when the search calculation results are transmitted in installments, the information terminal starts the route guidance upon receiving, at least, search calculation results corresponding to an area near the start point.

24. A route guidance method for providing route guidance by exchanging information related to a recommended route from a start point to a destination between an information terminal and an information distribution center, comprising in sequence:
(a) a step in which the information terminal transmits information indicating the start point and the destination to the information distribution center;
(b) a step in which the information distribution center obtains route guide information for a route from the start point to the destination through a search calculation;
(c) a step in which when a communication device with a data transmission speed equal to or lower than a predetermined value is connected to the information terminal, the information distribution center splits results of the search calculation and transmits the search calculation results to the information terminal in installments; and
(d) a step in which when the search calculation results are transmitted in installments, the information terminal starts the route guidance upon receiving, at least, search calculation results corresponding to an area near the start point.

25. A route guidance method for providing route guidance by exchanging information related to a recommended route from a start point to a destination between an information terminal and an information distribution center, comprising in sequence:
(a) a step in which the information terminal transmits information indicating the start point and the destination to the information distribution center;
(b) a step in which the information distribution center obtains route guide information for a route from the start point to the destination through a search calculation;
(c) a step in which the information distribution center transmits to the information terminal route information contained in results of the search calculation in a batch and transmits guide information contained in the results of the search calculation to the information terminal in installments by splitting the guide information; and
(d) a step in which the information terminal starts the route guidance upon receiving the route information included in the search calculation results and at least guide information for an area near the start point included in the search calculation results and transmitted in an installment.
